(19) United States
(12) Patent Application Publication
(10) Pub. No.: US 2026/0045140 A1
(43) Pub. Date: Feb. 12, 2026

(54) VIRTUAL ARTIFICIAL INTELLIGENCE-BASED GAMEPLAY ASSISTANT

(71) Applicant: WIZARDS OF THE COAST LLC, Renton, WA (US)

(72) Inventors: Maximilian Steven Kaufmann, Maple Valley, WA (US); Brianne M. Lovett, Seattle, WA (US)

(21) Appl. No.: 19/294,031

(22) Filed: Aug. 7, 2025

Related U.S. Application Data
(60) Provisional application No. 63/680,599, filed on Aug. 7, 2024.

(51) Int. Cl. G07F 17/32

(52) U.S. Cl. CPC G07F 17/323; G07F 17/3293

(57) ABSTRACT

Disclosed herein are systems and associated methods for adjudicating rules and providing gameplay advice during gameplay using an artificial intelligence (AI) model. The systems and methods include an AI model that assists users in querying rules for a game match by analyzing specific card interactions and game board states. The AI model is trained to request additional information when initial user queries lack sufficient detail for accurate adjudication of the query. The system receives a query from a user, determines a confidence score for adjudicating the query based on gameplay rules and card data, and, if the confidence score is below a predefined threshold, requesting further clarification. If the confidence score exceeds the threshold, the AI model provides a response to adjudicate the query.

### CROSS-REFERENCE TO RELATED APPLICATION(S)

The present application claims the benefit of U.S. Provisional Patent Application No. 63/680,599 entitled “VIRTUAL ARTIFICIAL INTELLIGENCE-BASED GAMEPLAY ASSISTANT” and filed Aug. 7, 2025. The content of the foregoing application is incorporated herein by reference in their entirety.

### BACKGROUND

Artificial intelligence (“AI”) models often operate based on extensive and enormous training models. The models include a multiplicity of inputs and how each should be handled. Then, when the model receives a new input, the model produces an output based on patterns determined from the data the model was trained on.

Large language models (“LLMs”) are trained using large datasets to enable them to perform natural language processing (“NLP”) tasks such as recognizing, translating, predicting, or generating text or other content. One example of an existing LLM is Gemini. A recent trend in AI is to make use of general-purpose generative AI applications built on LLMs. An example of such an application is the ChatGPT family of OpenAI models, Llama developed by Meta, Gemini developed by Google. These sorts of models make use of a natural language chat interface for humans to make requests to the AI. At the time of filing, general-purpose generative AI's first attempt at responding to a user's queries is middling and requires query refinement from the user. Over the course of a given chat session, the user refines their queries, and the general-purpose model provides a better response.

### BRIEF DESCRIPTION OF THE DRAWINGS

FIG. 1 is a diagrammatic view illustrating generally a validation process in accordance with the invention.

FIG. 2 is a flowchart illustrating a method of validating data.

FIG. 3A is a diagram illustrating one embodiment of the architecture of the validation framework as applied to validating language model outputs in a tabletop game.

FIG. 3B is a diagram illustrating one embodiment of the architecture of the validation framework as applied to validating user inputs in a tabletop game.

FIG. 4 is a flowchart illustrating an example architecture of an AI-based gameplay assistant for a card game.

FIG. 5 is a flowchart illustrating an example method of adjudicating rules and providing gameplay advice for a card game during gameplay using an AI model.

FIG. 6 is a diagram illustrating an example user interface of an AI-based gameplay assistant for a card game.

FIG. 7 is a flowchart illustrating an example method of suggesting deck construction based on one or more inspiration cards.

FIG. 8 is a block diagram illustrating an example computer system, in accordance with one or more embodiments.

FIG. 9 is a high-level block diagram illustrating an example AI system, in accordance with one or more embodiments.

### DETAILED DESCRIPTION

Tabletop games, such as card games, have been popular forms of entertainment. Card games involve the use of a deck of cards as the primary tool for gameplay, whether the cards are of a traditional design or specifically created for the game. Card games vary widely in terms of rules, objectives, and complexity, ranging from simple games such as Go Fish, which is often played by children, to more intricate and strategic games such as Magic: The Gathering and Yu-Gi-Oh! Card games can be played individually, such as in Solitaire, or with multiple players, such as Magic: The Gathering. Card games are typically played with a deck or pack of playing cards which are identical in size and shape. Each card has two sides, the face and the back. Typically, the backs of the cards are indistinguishable. The faces of the cards can all be unique, or there can be duplicates.

However, many players, especially newcomers, find it challenging to grasp the intricate rules, card interactions, and strategic depth required to play effectively. Card games such as Magic: The Gathering involve a vast array of cards (e.g., Magic: The Gathering includes over 25,000 cards), each with unique abilities and interactions that create highly complex scenarios. For instance, understanding how different continuous effects interact or how specific card combinations are used for strategic advantage requires a deep knowledge of the game's mechanics. The complexity oftentimes is a barrier to entry, as new players feel overwhelmed and discouraged by the steep learning curve. Consequently, the game's appeal and accessibility to a broader audience are limited, as potential players are deterred by the perceived difficulty. While specific examples are provided in reference to Magic: The Gathering (“Magic”), the embodiments herein are applicable to other tabletop games where human players are called upon to adjudicate/resolve game scenarios during play or build custom decks of cards to play with. The examples provided in this document are intended as illustrative and are not limiting. Any other game referenced in this document, and many others unmentioned are equally appropriate after appropriate modifications.

To address the limited accessibility of traditional card games, a gameplay assistant uses generative artificial intelligence (i.e., generative AI, GenAI) technologies to aid accessibility and provide players with gameplay rule adjudications and/or gameplay advice. In response to receiving a user query (e.g., command set, input, prompt, request), the gameplay assistant outputs clear, accurate, and contextually relevant explanations of game mechanics and card interactions answering the user's query. For example, the gameplay assistant determines the game conditions required to resolve the query (e.g., the sequence in which cards are played, the state of the game board) using a Retrieval-Augmented Generation (“RAG”) framework. The RAG framework combines retrieval-based and generation-based models (e.g., LLMs), allowing the gameplay assistant to fetch relevant information from a pre-compiled database of game rules and card texts and subsequently generate responses using the information. Using an RAG framework ensures that players of various skill levels are able to access the knowledge the players need to enjoy the game and reduce the time spent searching for niche rules within the game. The gameplay assistant not only simplifies the learning process for newcomers but also efficiently adjudicates complex scenarios that arise between experienced players.

The integration of generative AI technology in tabletop games enables a unique and dynamic gameplay experience. For example, in a card game, an AI engine generates rule adjudications or gameplay advice based on input parameters such as card types, game rules, and game board states. This allows players to receive near real-time, contextually relevant guidance on complex interactions within the game, which resolves disputes and ensures fair and consistent gameplay. A technical problem to solve in integrating a tabletop game rules engine into an AI model is that the rules of a game, such as a card game (e.g., Magic), are functionally a programming language that is not self-executing. Unlike traditional programming languages used to write software, the game employs humans to carry out the instructions of the game and make choices within the game where able. Notably, there are examples in popular media of people using the rules system of Magic to build a human-executed Turing machine. Like a programming language, the rules of a game, Magic included, follow a strict logical structure that has a “correct” answer for every scenario.

LLMs are generally able to output software code that performs requested functions. To accomplish that task, the LLMs were trained by large databases of code that was capable of executing into particular functions. The problem posed by rules adjudication of a game is something of the reverse—given a game scenario, the model is being asked to explain what happens (e.g., give a set of code, ask what the code does). Some LLMs are able to provide explanations of a set of program code; however, game rule adjudication does not have the sheer number of examples to use as training data that program code does. Thus, a problem inherent in building an AI game tutor is teaching the AI model a very uncommon language that follows a strict set of interpretive logic. Code repositories, such as GitHub, have plentiful examples of executable code-but execution of games, like Magic, are performed by people and the examples are less plentiful.

Another technical hurdle is that LLMs do not exhibit understanding of any particular topic, but rather employ predictive techniques to string together characters. Even so, if an LLM is queried regarding simple algebra without sufficient information, the LLM will typically respond that it does not have enough information. Conversely, when posed a game rules question without enough information, the model will confidently respond with an answer treating the game rules question as if it were a question posed in a human language (e.g., English, Spanish, Japanese) as opposed to a programming language or mathematical language with a fixed correct answer. The issue of language is exacerbated due to the manner in which humans articulate questions regarding game rules. Questions are frequently phrased with colloquial terms or slang. Despite the inarticulate (e.g., fuzzy) manner the questions are phrased, there is nevertheless a correct (and not a fuzzy) answer.

Playing Magic further includes generally applicable advice that varies by context. Magic is not actually one single game, but many different games (or formats) that share a base set of rules. Whether a given game piece (e.g., card) is “good” in the game or how many of particular types of game pieces (e.g., how many land cards) should a player select as they construct their deck varies by context of the format being played. Each format has relatively small variations to the rules that have dramatic impacts on the manner the game is played. A further issue posed in training an AI model on game rules is identifying the context in which those rules and meta information about the game applies from limited user prompting.

However, there is the potential for erroneous, misleading, or otherwise undesirable, responses from the generative AI engine. For example, the generative AI engine may lack the ability to verify the veracity of statements made by users. Without verification, the generative AI engine may generate responses based on false information provided by users. Another example occurs when the training data used to develop the generative AI engine contains biases or skewed representations. In that case, the generated content may inadvertently reflect those biases, potentially leading to inappropriate or inaccurate responses. Additionally, if the generative AI engine encounters a situation where the generative AI engine lacks adequate information to generate a response, the generative AI engine will attempt to infer or guess, potentially leading to inaccurate content. Another concern is when users provide input that is unconventional, vague, or entirely unrelated to the intended context, which challenges the generative AI engine's ability to generate appropriate responses. Input as described are due to, for example, an attempt to jailbreak the generative AI engine, a form of hacking that aims to bypass an AI model's ethical safeguards and elicit prohibited information.

Even in potentially favorable circumstances, a generative AI typically provides what a user asks for in a literal sense and does not accommodate for what the user really wants to know. Humans will provide imprecise input that receives similarly imprecise output. For example, a human will request a game ruling question, and the generative AI will take the path of least computation and provide an answer even if the prompt did not provide enough information to accurately answer the question. The human did not specify the additional parameters of the question, and the model accordingly did not use those parameters. Further, a user can only do so much with a given query. Queries to generative models typically have character maximums, or query buffers of a limited size in order to control execution speed. In such circumstances, a user's input (e.g., the game ruling question) may only be as specific as the query buffer allows.

To address the unwanted generative AI engine responses, the validation framework seeks to ensure the accuracy, relevance, and reliability of AI-generated content in any game system. By upholding the criteria, the validation mechanism enhances user trust and improves the gameplay experience. The validation process is orchestrated by an amalgamation of distinct AI models and/or heuristic evaluations, each tailored to address specific facets of content assessment. These models are integrated within an architectural superstructure that allows for synchronized execution. The architectural superstructure acts as a computational backbone, facilitating the parallel execution of independent validation models. The architectural superstructure leverages pre-loaded query context to validate specific checks pertaining to the use of a main model. The pre-loaded query context functions as parameters that guide the distinct AI models in discerning compliance with predetermined model-driven conditions that limit undesirable input and output to the model. The pre-loaded query context serves as a contextual framework, enabling the gameplay assistant to dynamically adapt validation criteria based on the unique characteristics of both the main model and the user input.

The invention is implemented in numerous ways, including as a process; an apparatus; a system; a composition of matter; a computer program product embodied on a computer-readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description that references the accompanying figures follows. The scope of the invention is limited only by the claims and the invention encompasses numerous alternatives, modifications, and equivalents. Numerous specific details are set forth in the following description in order to provide a thorough understanding of the disclosure. These details are provided for the purpose of example and the invention may be practiced according to the claims without some or all of these specific details. For the purpose of clarity, technical material that is known in the technical fields related to the invention has not been described in detail so that the invention is not unnecessarily obscured.

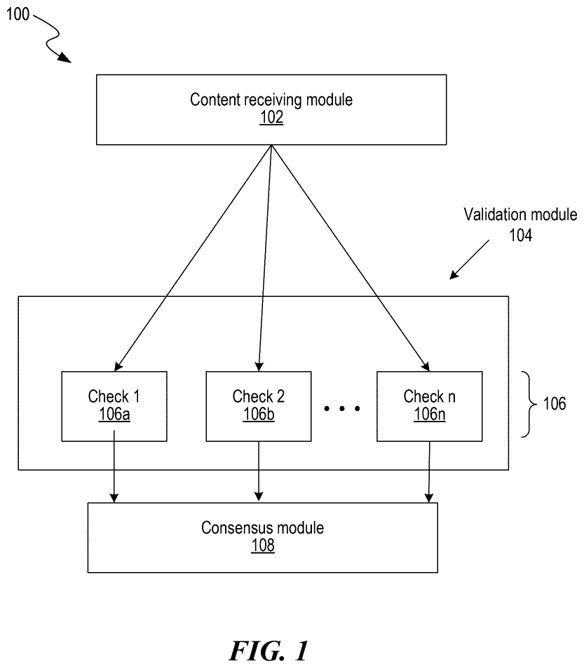

FIG. 1 is a diagrammatic view illustrating generally a validation framework 100. The validation framework 100, in some embodiments, has a content receiving module 102 that is configured to receive inputs from a user or outputs from a model. In some embodiments, the content receiving module 102 receives an output of a generative AI engine comprising of neural network-based architecture, such as a large language model (“LLM”). The output of the model, in some embodiments, is in a string format. However, in scenarios where JSON formatting is required, the configuration is specified within the pre-loaded query context. As is described in greater detail below, in the context of a tabletop game, the content receiving module 102 is configured to receive a rule adjudication or game advice (e.g., a proposed game operation or response) request from a user in some embodiments. In some embodiments, in the context of a tabletop game, the content receiving module 102 is configured to receive the output from a generative AI engine, wherein the output is in the form of at least a game response. A game response specifically pertains to the entirety of one or more rule adjudications or gameplay advice, which include, in some embodiments, an answer and the explanation of the answer (e.g., in the case of a request asking about how a particular card interaction plays out, the explanation can include a description of what the card(s) do and the current board state).

The data received by the content receiving module 102 is transmitted into a validation module 104. In some embodiments, the validation module is comprised of a validation model 106. In some other embodiments, the validation module is comprised of a plurality of validation models, 106a, 106b, and so on through 106n, for a total of n models, where n equals the number of validation models. The data received by the content receiving module 102 is validated through the validation model(s) 106a through 106n. In some embodiments, the data is validated by the validation model(s) 106a through 106n in tandem using a parallel data processing mechanism. In some embodiments, the parallel data processing mechanism includes running a plurality of central processing units (CPUs) concurrently on a single system.

Each of the validation model(s) 106a through 106n reviews some predefined aspect of the input to the content receiving module 102. A distinctive element of each of the validation model(s) 106a through 106n is pre-loaded query context (e.g., criteria) that is employed along with the input to the content receiving module 102. In some embodiments, the validation model(s) 106a through 106n employ varied model architecture and training sets. In some embodiments, the same model architecture and training set is employed for the validation model(s) 106a through 106n.

In some embodiments, one or more of the validation models 106a through 106n includes a topic check. The topic check is pre-loaded with a query context that encompasses an extensive list of prohibited topics, encapsulated in a structured data format such as JSON. Through training techniques such as NLP and topic modeling, the model identifies and denies queries pertaining to the topics in a variety of means, such as utilizing algorithms like support vector machines (SVM) for classification. In some embodiments, through a process of iterative analysis, the topic check dissects the deny list, discerning patterns and underlying characteristics associated with the proscribed topics. In some embodiments, the discernment process involves the extraction of semantic, syntactic, and contextual features from textual data, enabling the model to distinguish between permissible and impermissible content.

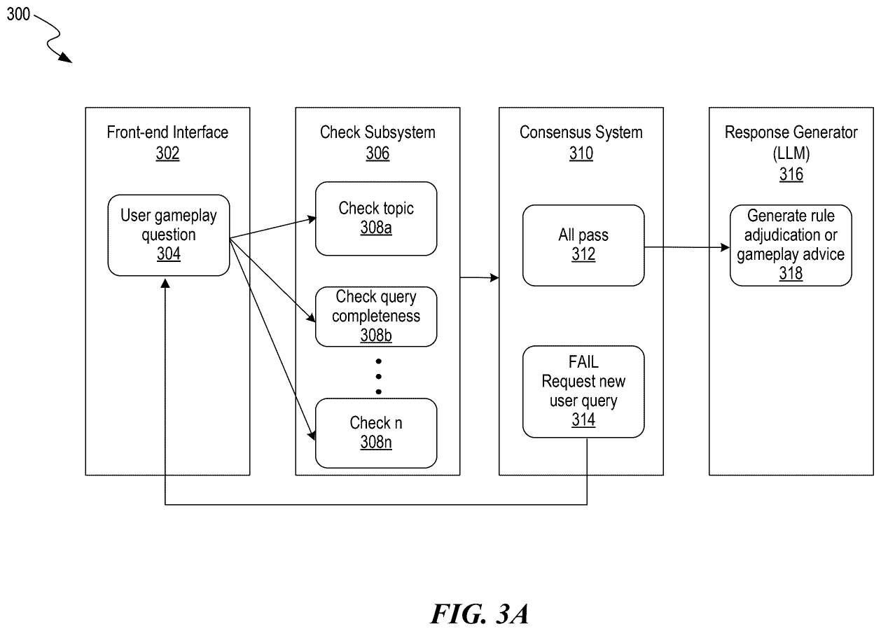

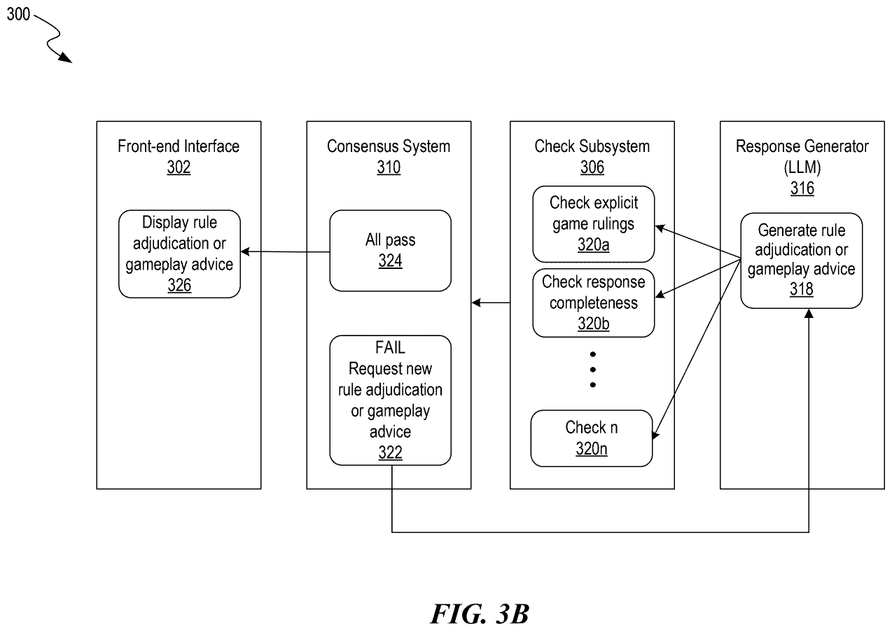

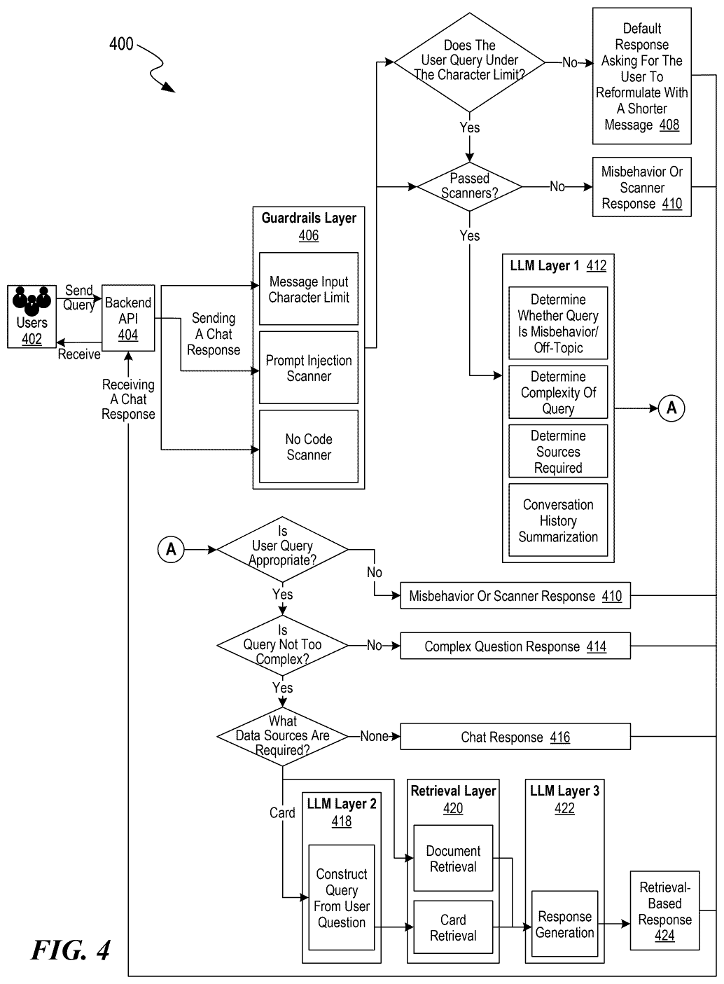

For instance, when validating queries related to a particular game, the gameplay assistant first determines if the question pertains to the game. If not, the query is rejected, as discussed further with reference to FIGS. 3A, 3B, and 4. The topic block is approachable either explicitly (e.g., the user asked a question about an unrelated game or not a game at all, e.g., “why is the sky blue?”) or implicitly (e.g., the user asked for questions about a particular card or feature not within the game). However, a given topic requested may be “The Lord of the Rings,” a franchise that has a crossover set in Magic. In such circumstances, in some embodiments, a bypass is enabled by framing the topic check as to whether the game question is more related to the unrelated topic (e.g., general Lord of the Rings lore) or more related to an allowed topic (e.g., the specific Magic crossover set).

In some embodiments, topic checks are executed individually and in parallel (e.g., each topic is independently evaluated), and in some embodiments, multiple topics are screened simultaneously with one set of pre-loaded query context. A similar principle applies to other validation models 106a through 106n described below.

In some embodiments, one or more of the validation models 106a through 106n includes a localization check. The pre-loaded query context for the localization check comprises geospatial data in a standardized format, allowing for geographical determination. Through geospatial algorithms, the model assesses whether the generated content remains relevant and appropriate for the geographic location of the users or user profiles initiating the query, using techniques such as coordinate-based calculations and geofencing. Appropriateness is structured as cultural awareness. In such cases, the pre-loaded query context includes variables that are determined by the location of the user. An example pre-loaded query context is “Is using card X (as received from the user input) something that players in format Y are likely to encounter in local tournaments or casual play?”

In some embodiments, one or more of the validation models 106a through 106n includes a completeness check (discussed with further reference to FIG. 4). The completeness of content, such as a user question, refers to the inclusion of all parameters (e.g., context) for the subsequent AI model(s) (e.g., the RAG framework discussed in FIGS. 3A, 3B, and 4) to generate an accurate and contextually appropriate response to the content. In some embodiments, the pre-loaded query context allows the generative AI engine to check the completeness of the question based on format availability and/or format rules. For example, a player asks a fundamental question that exists across various formats in the game Magic, such as “How many lands should I put in my deck?” However, in a limited or draft format, where the deck size minimum is 40 cards, the typically 17 lands are used. For one-on-one constructed formats, where the deck size minimum is 60 cards, typically 24 lands are used, with some deck archetypes using as few as 18 lands. In the commander format, where the deck size is exactly 100 cards, typically include 36 to 40 lands.

In some embodiments, one or more of the validation models 106a through 106n includes a hallucination check. The pre-loaded query context for the hallucination check specifies parameters for evaluating data veracity and coherence, allowing the check to use techniques such as sequence-to-sequence modeling and attention mechanisms. If the model detects a deviation from established criteria, the model interrupts the query and invokes the generative AI engine to restart, employing mechanisms such as process control to determine whether the model rectifies the erroneous data. The hallucination check operates on the premise that generative Al output is produced on a per-character basis where the AI is predicting the next character in a given output as the output is being produced. Interrupting the main model, or requesting the main model start again from the middle of a given output causes the model to reevaluate a given output from an intermediate position of the output (e.g., “try again from here”) and reduces model hallucination.

In some embodiments, one or more of the validation models 106a through 106n includes a profanity check. In some embodiments, profanity check integrates NLP techniques like part-of-speech tagging and sentiment analysis and is equipped with a pre-loaded query context that comprises a comprehensive list of profane language and associated indicators. The list allows the check to identify instances of profanity within the generated content or gauge the likelihood of the content inducing profane language.

In some embodiments, one or more of the validation models 106a through 106n includes a jailbreak check. The pre-loaded query context for the jailbreak check is tailored to identify instances where a user attempts to manipulate the model by employing obscure or nonsensical queries. In some embodiments, the jailbreak check is accomplished using advanced pattern recognition algorithms or anomaly detection techniques. An example of a pre-loaded query context employed to avoid jailbreaking is the query, “Is user input X typically considered human comprehensible speech?” Where the expected user input is always expected to be human-comprehensible, user input that is not decipherable by humans is anticipated to be an attempt at jailbreaking the main model.

In some embodiments, one or more of the validation models 106a through 106n includes an accuracy check. The pre-loaded query context for an accuracy check is designed to evaluate the factual correctness and authenticity of the output generated by the AI engine. In some embodiments, the check involves utilizing techniques such as fact-checking algorithms and knowledge-based comparisons. For example, in the context of a tabletop game, the gameplay assistant checks for explicit applicable game rulings (e.g., rulings of card interactions in a card game). If such rulings are available, the gameplay assistant applies them directly. Otherwise, the AI engine attempts to extrapolate based on existing rules and interactions. In some embodiments, the gameplay assistant determines whether the prompt provides sufficient information (using methods discussed in FIG. 4). If the information is lacking but can be inferred, the gameplay assistant proceeds. Otherwise, the gameplay assistant prompts the user for additional details, as discussed further with reference to FIGS. 3A, 3B, and 4. Similarly, in some embodiments, validation models 106a through 106n includes an evaluation of whether the answer requires a human to choose an order of operations. If so, the gameplay assistant uses a preconfigured order of operations based on game mechanic criteria.

An example of a predefined query context employed to determine accuracy is to employ output from one model in a query that requests “Is model output X factually supported by explicit game rules?” Where the pre-loaded query context is employed in the context of a tabletop game, the output is a rule adjudication or gameplay advice. In such circumstances, an example pre-loaded query context is, “Is the output advice A valid under current game phase B according to the game rules?” Other checks include determining whether the rule adjudication is consistent with existing rules and precedents (e.g., explicit game rulings). For example, an example pre-loaded query context is, “Does the rule adjudication X for card interaction Y comply with explicit game rulings Z?”

In some embodiments, one or more of the validation models 106a through 106n includes a format check. The format check is equipped with a pre-loaded query context that establishes specific formatting standards for the generated content. The check ensures that the output from the generative AI engine adheres to these predefined formatting guidelines.

In some embodiments, one or more of the validation models 106a through 106n includes a user feedback check. In some embodiments, the pre-loaded query context includes user ratings, comments, preferences, and other relevant feedback elements. In some embodiments, the check leverages user-provided feedback through sentiment analysis or collaborative filtering techniques to assess the quality and effectiveness of the system output. For example, if users frequently rate a particular rule adjudication output by the gameplay assistant as unclear or incorrect, the gameplay assistant flags the feedback for further review or prevents the output from displaying. Similarly, if users consistently prefer certain types of game advice or find specific explanations particularly helpful, the gameplay assistant prioritizes these types of responses in future interactions.

In some embodiments, one or more of the validation models 106a through 106n includes a difficulty level analysis check. The pre-loaded query context for the difficulty level analysis check analyzes the complexity of the generated content, ensuring that the generated content aligns with the cognitive capabilities and knowledge levels of the intended users. In some embodiments, the check is executed by employing algorithms such as decision trees or ensemble methods. For instance, a decision tree first evaluates whether a ruling involves basic game mechanics or complex interactions, and then classifies the ruling as easy, medium, or hard. Ensemble methods, which combine multiple algorithms to improve accuracy, can further refine the classification by considering additional factors such as user feedback and/or historical data on similar rulings. In some embodiments, the complexity of the output adjudication depends on the intended difficulty of the ruling. For example, a more difficult ruling would explain specific layers and timestamps, whereas an easier ruling simply states the final outcome of the interaction.

In some embodiments, one or more of the validation models 106a through 106n includes a temporal relevance check. The pre-loaded query context for the temporal relevance check enables the check to evaluate whether the generated content remains pertinent and up-to-date in relation to the prevailing temporal context. In some embodiments, techniques such as temporal analysis or trend prediction algorithms are used. For example, a temporal relevance check assesses whether a ruling adjudication output by the AI engine on a specific card interaction is still valid after a recent rules update or whether advice on deck-building strategies takes into account the latest set releases and the releases' impact on the meta-game. The gameplay assistant, in some embodiments, compares the date of the content generation with the dates of the latest rules updates or set releases.

The validation models 106a through 106n, each equipped with a distinct pre-loaded query context, validate the data received by the content receiving module 102. The query context dictates which kind of uncertainty or variability the particular validation model is measuring. For example, if the validation models 106a through 106n included a topic check, localization check, and profanity check, the consensus module 108 will validate the data received by the content receiving module 102 only if the data is not on the deny list of topics, appropriate for the geography of users or user profiles, and does not have instances of profanity, respectively.

Reference to AI models herein employs either platform native models or external application program interfaces (APIs). External APIs (e.g., ChatGPT, MidJourney, Llama, Bard, etc.) are communicatively coupled to a game platform (i.e., the gameplay assistant). The pre-loaded query context is initially configured by a game platform. At least in circumstances where the AI models are accessed through external APIs, the pre-loaded query context remains stored with the game platform and is delivered to the validation models 106a-106n when triggered.

In some embodiments, the consensus module 108 then receives the output of the validation models 106a through 106n and validates the data received by the content receiving module 102 if the plurality of checks performed by the validation models 106a through 106n returns a positive result. If any one of the validation models 106a through 106n returns a negative result, the consensus module 108 will not validate the validation models 106a through 106n.

In some embodiments, the consensus module 108 is equipped with a load-balancing algorithm, which serves to dynamically allocate processing resources among the validation models 106a through 106n. In some embodiments, the load-balancing algorithm takes into account factors such as algorithmic intricacy, data volume, or computational intensity. In some embodiments, the load-balancing algorithm dynamically monitors the current system load by tracking metrics like CPU utilization, memory usage, and I/O operations in real-time to make informed decisions regarding the allocation of processing resources. Furthermore, in some embodiments, the algorithm considers the urgency of validation checks. For instance, time-sensitive validations may be prioritized over tasks with less immediate relevance, ensuring that the time-sensitive content assessments are conducted promptly.

In some embodiments, the load-balancing algorithm has knowledge of the volume of data sent and the size of each query, but lacks control over the model's underlying parameters. Thus, the load balancer delivers the queries in terms of their size, speed, and operations, but cannot directly influence the model's internal workings. In such a case, for example, instead of delivering a query containing ten different gameplay questions to the validation module 104 at one time, the load-balancing algorithm chooses to send ten separate queries to the validation module 104, one for each question, allowing parallel execution.

In some embodiments, the algorithm takes into consideration the context accompanying each question, gauging factors such as query complexity or time sensitivity. For example, when the user is actively waiting on the generated rule adjudication, the gameplay assistant may opt for a more parallelized, one-per-query validation approach such that the game platform delivers portions of the generated response as each portion individually becomes cleared/available. Conversely, during moments when the user is preoccupied and the game has available processing time, the load-balancing might choose to validate multiple questions within the same query to a given validation model.

In some embodiments, there is a response mechanism to help the load-balancing algorithm determine the algorithm's course of optimization. Based on an assessment of the query's size and context, and/or a current game state, the response mechanism decides whether it's advisable to divide the query into smaller, more manageable segments. For example, where ten rulings are sent for validation, and six of them fail to meet the validation checks performed by validation models 106a through 106n, a response mechanism is triggered. The time the user takes to review the four successfully validated rulings creates a window of opportunity for the gameplay assistant to generate replacements for the remaining six. In this example, there is potential to process all six replacements simultaneously. However, in a scenario where nine out of ten rulings fail the validation checks performed by validation models 106a through 106n, and only one ruling buffer is available, a faster approach is warranted. In this case, the gameplay assistant may opt to validate rulings one at a time in parallel, ensuring that by the time the user reviews all presently available successfully validated rulings, there are further successfully validated rulings available.

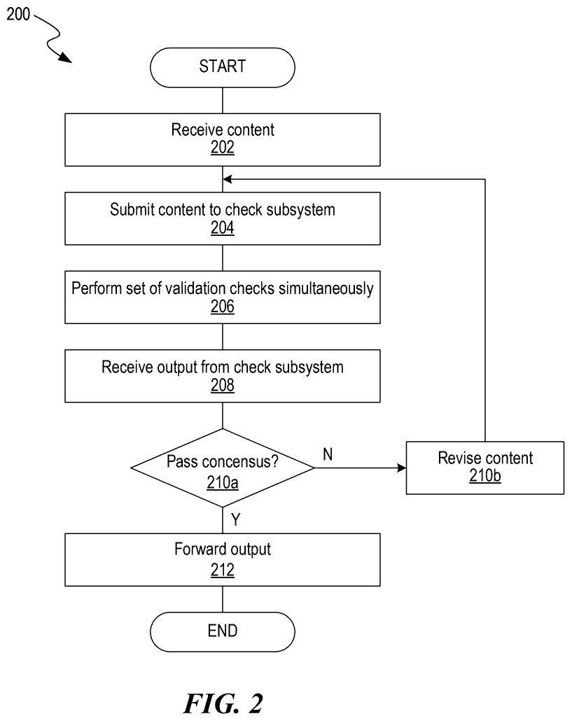

FIG. 2 is a flowchart illustrating a method 200 of validating data. The process initiates with the reception of content in step 202. In some embodiments, the content consists of a user-requested gameplay question, user-requested gameplay advice, gameplay assistant (e.g., AI engine) generated rule adjudication, or gameplay assistant generated gameplay advice. For example, the content is the output of a generative AI engine employing a neural network-based architecture. In some embodiments, the content encompasses the subdivided output of a model.

For instance, if the model generates a set of ten rulings in response to a user query including ten questions, each of the rulings are individually subjected to parallel validation, allowing for independent assessment rather than being processed as a collective group, thereby improving processing speed. Further examples are discussed with reference to FIG. 1.

Subsequently, the received content is submitted to a check subsystem in step 204. Once in the check subsystem, step 206 determines the content's compliance with a predetermined model-driven condition. In some embodiments, the predetermined model-driven condition is predetermined by the pre-loaded query context. For example, a predetermined model-driven condition is that the content cannot fail one or more specific validation checks, such as a hallucination check, profanity check, localization check, and jailbreak check. Further checks are discussed with reference to FIG. 1.

A parallel processing mechanism executes a set of independent validation models simultaneously in step 206 to complete the validation checks, returning the results of the independent validation models in step 208. By doing so, the gameplay assistant significantly expedites the completion of validation checks, resulting in a streamlined and expeditious assessment of the received content. In some embodiments, the parallel processing mechanism utilizes a load-balancing algorithm that dynamically allocates processing resources among the independent validation models in response to computational demand. In certain embodiments, the load-balancing algorithm takes into account various factors, such as the complexity of the validation models, the current computational load on the gameplay assistant, and the urgency of the validation checks.

In step 210A, the outputs received from the check subsystem in step 208 are validated through a decision point. In some embodiments, upon encountering a failed consensus check, the content is revised in step 210B. In one example, the gameplay assistant opts for content discarding. In such embodiments, the game either requests additional content or relies on already available and stored content. Where additional content is requested, the game platform makes use of generative techniques to obtain revised content, such as generative adversarial networks (GANs) or recurrent neural networks (RNNs). In another example, the gameplay assistant prompts alternative validation approaches such as parameter adjustments (e.g., varied query context) to produce revised outputs from the validation models 106a through 106n. In another example, where the content is a user input, a game graphical user interface (GUI) signal is issued, signifying the need for new user input. For example, in the context of Magic, if the order in which a player played two particular cards is needed to adjudicate the card interaction, the gameplay assistant requests the new user input using methods discussed with reference to FIG. 4.

The revised content generated in step 210B is then directed back to step 204. Here, a new iteration of the content generation process is initiated. The revised content is subjected to the same validation process. In instances where the revised content still does not attain consensus, in some embodiments, the gameplay assistant iterates through the re-validation process multiple times until consensus is achieved or a predefined threshold for revision attempts is reached.

Upon successful validation, the content is obtained. Successful validation signifies that the content has met the required criteria. In some embodiments, the content is then forwarded to a front-end interface in step 212. The front-end interface serves as the interface through which the user interacts with the gameplay assistant. In some embodiments, the front-end interface encompasses visual or auditory elements to facilitate user engagement.

Validating Game Systems

The disclosed architecture is designed to integrate with a tabletop game environment, ensuring that user-generated inputs align with predefined content guidelines and maintain accuracy and relevance. The architecture addresses the unique challenges posed by the tabletop game context, where the accuracy of rule adjudications or gameplay advice directly affects the overall gameplay experience.

FIG. 3A is a diagram illustrating one embodiment of the architecture of the validation framework 300 as applied to validating user inputs in a tabletop game. In some embodiments, the validation framework operates beginning with the front-end interface 302. The user will request a gameplay question 304. For example, the user interacts with a chatbot to ask a certain gameplay question (e.g., “Can I use ‘Counterspell’ to stop ‘Lightning Bolt’?”). Similarly, a user uploads a picture of a card to a computer vision model to identify and validate the card's details and interactions. The front-end interface 302, in some embodiments, is a remote application facilitating tabletop gameplay such as SpellTable, a platform that allows users to play Magic remotely via webcam. The gameplay assistant tags and recognizes when a given card is played on screen. Furthermore, in some embodiments, the front-end interface 302 is a digital game interface like Magic Arena, an online version of Magic, where players input their gameplay actions (e.g., cast spells, summon creatures, and perform other in-game actions) using the digital controls provided by the digital game interface.

The user-requested gameplay question 304 is then scrutinized under a check subsystem 306, which includes, in some embodiments, a validation model. In other embodiments, the check subsystem 306 includes a set of independent validation models 308a through 308n. The set of independent validation models 308a through 308n each checks the user-requested gameplay question 304 to determine whether the user-requested gameplay question 304 complies with the consensus criteria. As described above, in some embodiments, the set of independent validation models 308a through 308n is executed simultaneously. By leveraging parallel processing, the framework significantly expedites the check subsystem, increasing the responsiveness of the gameplay assistant. In some embodiments, the parallel processing capability of the architecture is facilitated by concurrent execution threads at each node, leveraging multi-core processing capabilities of the underlying hardware.

Subsequent to the independent validation phase, the user-requested gameplay question 304 is channeled into a consensus system 310. The consensus system 310 ensures that only the user-requested gameplay question 304 that meets the consensus criteria proceeds to the next stage. In some embodiments, there are two possibilities once the user requested gameplay question 304 enters the consensus system 310. The first possibility is that the user-requested gameplay question 304 meets consensus criteria 312. The second possibility is that the user-requested gameplay question 304 fails one or more of the consensus criteria 312. If the user-requested gameplay question 304 meets the consensus criteria 312, the user-requested gameplay question 304 is directed towards the response generator 316. In some embodiments, there is a model superstructure between the response generator 316, the front-end interface 302, and the check subsystem 306. In some embodiments, the front-end interface 302 stands as the initial node, acting as the ingress point for the user gameplay question 304.

In some embodiments, the response generator 316 comprises of neural network-based architecture, such as an LLM. In some embodiments, the response generator is a generative AI model that operates as a deep neural network (DNN) with multiple layers of long short-term memory (LSTM) cells. These cells facilitate sequence-to-sequence processing, enabling the model to comprehend and respond to user input with a contextual understanding of various applications, such as the particular tabletop game. For example, a response generator 316 generates a rule adjudication or gameplay advice 318 in response to the user gameplay question 304.

When a user gameplay question 304 is received, the response generator 316 parses the user gameplay question 304 to identify elements such as card names, actions, and/or game state conditions. The response generator 316 uses a Retrieval-Augmented Generation (RAG) framework to retrieve information containing relevant rules and card texts from the corpus. A RAG framework is a hybrid approach that integrates information retrieval layers (e.g., retrieval layer 420 in FIG. 4) with generative models (e.g., LLM layers 418, 422). The retrieved information is used to construct a context for the query, which is input into the generative component(s) of the RAG framework. The generative component(s) generate the rule adjudication or gameplay advice 318, one token (e.g., words, subwords, characters) at a time. When generating a new token, the generative component(s) consider the previously generated tokens and the overall context to ensure that each new token is appropriate and contributes to a meaningful response. Methods and examples of the RAG framework are discussed in further detail with reference to LLM layer 418, retrieval layer 420, and LLM layer 422 in FIG. 4.

On the other hand, if the user-requested gameplay question 304 does not meet the consensus criteria, the consensus system 310 fails and a new gameplay question is requested 314 from the user through the front-end interface 302. For example, in cases where a user includes explicit language or offensive content in their input, the profanity check would identify the content and reject the input. In another example, if a user attempts to bypass the gameplay assistant by inputting a series of random characters, the jailbreak check would recognize the input as an attempt to manipulate the gameplay assistant and prompt a revision. Further examples of validation checks are discussed with reference to FIG. 1.

FIG. 3B is a diagram illustrating one embodiment of the architecture of the validation framework 300 as applied to validating language model outputs in a tabletop game. In some embodiments, there is a model superstructure between, the front-end interface 302, the check subsystem 306, and the response generator 316. In some embodiments, the response generator 316 stands as the initial node, acting as the ingress point for the generated rule adjudication or gameplay advice 318. In some embodiments, the response generator 316 is responsible for generating a rule adjudication or gameplay advice 318. The response generator 316 responds dynamically to user requests, generating rule adjudication or gameplay advice that responds directly to a user-requested gameplay question 304. For example, if the user requests a question (e.g., “What does ‘trample’ mean?), the response generator 316 responds with an answer (e.g., “When a creature with trample is blocked, it will do excess of damage to the defending player or planeswalker.”). In some embodiments, if the user requests a question that includes multiple card interactions (e.g., “What happens when a creature has ‘Deathtouch’ and ‘Trample’?”), the response generator 316 responds with an answer and an explanation of how the AI engine determined the answer (e.g., “Deathtouch means that any (nonzero) amount of damage counts as ‘lethal damage’ for the purposes of assigning combat damage. Only 1 damage from an attacking creature with deathtouch and trample has to be assigned to each blocking creature, and the rest can be assigned to the defending player or planeswalker.”).

The generated rule adjudication or gameplay advice 318 is then dispatched along the established pathways of the communication structure to the check subsystem 306. The rule adjudication or gameplay advice 318 is evaluated under a check subsystem 306, which, in some embodiments, includes one validation model. In other embodiments, the check subsystem 306 includes a set of independent validation models 318a through 318n. The set of independent validation models 320a through 320n each checks rule adjudication or gameplay advice 318 to determine whether rule adjudication or gameplay advice 318 complies with the consensus criteria. The set of independent validation models 320a through 320n are, in some embodiments, the same as or similar to the set of independent validation models 308a through 308n.

In some embodiments, the set of independent validation models 320a through 320n are different from the set of independent validation models 308a through 308n (e.g., specifically tailored to evaluating a rule adjudication and/or gameplay advice). For example, while a validation model 308a through 308n includes checking that the user-requested gameplay question 304 is related to the game and/or includes sufficient information to adjudicate the gameplay question 304, a validation model 320a through 320n includes checking that the rule adjudication or gameplay advice 318 follows any explicit rulings and/or fully answers the gameplay question 304.

As described above, in some embodiments, the set of independent validation models 320a through 320n is executed simultaneously. By leveraging parallel processing, the framework significantly expedites the check subsystem, enhancing the responsiveness of the system. In some embodiments, the parallel processing capability of the architecture is facilitated by concurrent execution threads at each node, leveraging multi-core processing capabilities of the underlying hardware.

Subsequent to the independent validation phase, the rule adjudication or gameplay advice 318 is channeled into a consensus system 310. The consensus system 310 ensures that only a rule adjudication or gameplay advice 318 that meets the consensus criteria proceeds to the next stage. If the rule adjudication or gameplay advice 318 meets the consensus criteria 324, the rule adjudication or gameplay advice 318 is directed toward the front-end interface 302. The front-end interface 302 displays the rule adjudication or gameplay advice 326 generated by the response generator 316. In some embodiments, the front-end interface 302 includes visual elements, auditory cues, and user prompts.

On the other hand, if the rule adjudication or gameplay advice 318 does not meet the consensus criteria, the consensus system 310 fails and a new rule adjudication or gameplay advice is requested 322 by the response generator 316. For example, if the response generator 316 generates a rule adjudication asserting that the card “Lightning Bolt” in Magic “deals 5 damage to any target,” the accuracy check would fail, as the statement is factually incorrect since the card “Lightning Bolt” only deals 3 damage. In some embodiments, the accuracy check calls an existing card database that includes card rules text to compare against.

FIG. 4 is a flowchart illustrating an example architecture 400 of an AI-based gameplay assistant for a card game. Example architecture 400 includes user 402, backend API 404, guardrails layer 406, LLM layers 412, 418, 422, character limit response 408, misbehavior or scanner response 410, complex question response 414, chat response 416, retrieval layer 420, and retrieval-based response 424. In some embodiments, implementations of example architecture 400 include different and/or additional components or are connected in different ways.

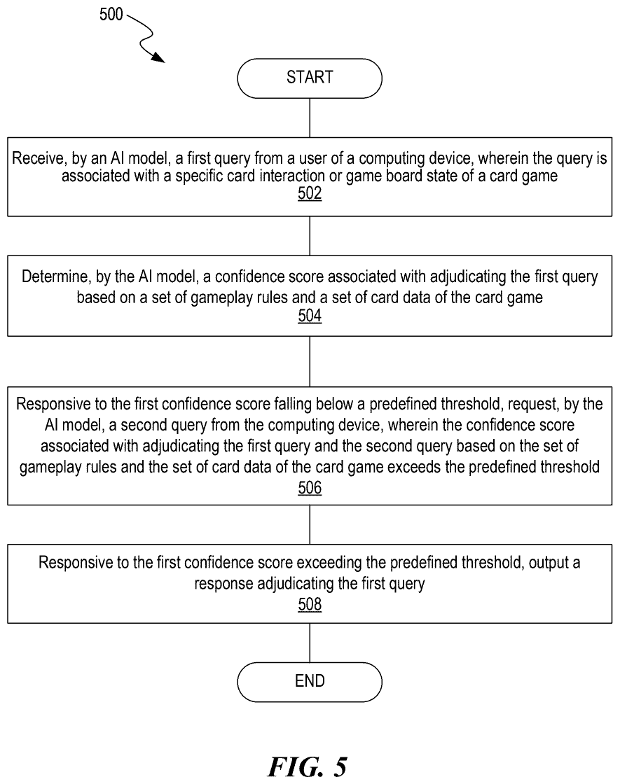

The user 402 interacts with the AI-based gameplay assistant (e.g., via a user interface of a software application such as a game application) by submitting one or more queries related to specific card interactions or game board states. For example, the AI-based gameplay assistant receives the query via a computing device that executes the AI-based gameplay assistant. The AI-based gameplay assistant maintains a digital representation of the current state of a card game. The digital representation identifies one or more of current card attributes (such as power, toughness, or abilities), player resources (such as life totals, mana, or hand size), or game phase information (such as turn order or combat phase), which, in some embodiments is retrieved from an external database (e.g., via an API). The queries are in the form of text, images, or video captures of the game board. In some embodiments, the user 402 is a player, judge, or spectator looking for accurate and timely information, such as seeking rule adjudication and/or strategic advice (e.g., a proposed game operation) during a game match. For example, a user 402 that is a player in a card game defined by gameplay rules that are applied to card data (e.g., Magic) asks a gameplay question such as “Can I use ‘Counterspell’ to stop ‘Lightning Bolt’?” or submits a photo of the current game board state to the AI-based gameplay assistant. Methods of intaking the query by the gameplay assistant and further examples of queries are discussed with reference to FIG. 5.

The backend API 404 allows the gameplay assistant to communicate between the user 402 and the AI model framework. The backend API 404 ensures that the user queries are transmitted to the appropriate components within the gameplay assistant (e.g., guardrails layer 406). The backend API 404 manages the responses from the AI model(s), delivering the responses back to the user 402. In some embodiments, the backend API 404 facilitates data flow between a user interface instantiated by the gameplay assistant that intakes the user query and the gameplay assistant's processing layers, handling tasks such as query parsing, response formatting, and error handling.

The guardrails layer 406 is the same as or similar to validation module 104 described with reference to FIG. 1. The guardrails layer 406 ensures that the gameplay assistant operates within predefined boundaries by monitoring the inputs (e.g., user queries) and outputs (e.g., gameplay assistant responses) of the gameplay assistant to prevent inappropriate or incorrect responses (e.g., by performing validation checks 106a-n in FIG. 1). For example, the guardrails layer 406 includes a message input character limit, which restricts user queries/messages to a maximum of 500 characters to prevent high latency. Additionally, the guardrails layer 406 employs a prompt injection scanner and/or a no code scanner, both using text classification models such as Hugging Face (HF) text classification models that categorize or label text data into predefined classes based on the text data's content.

In particular, the prompt injection scanner detects and filters out any attempts to manipulate the gameplay assistant through malicious prompts. The prompt injection scanner identifies, within incoming user queries, patterns or keywords that indicate an attempt to inject harmful or misleading instructions. In some embodiments, the prompt injection scanner uses machine learning models trained on a dataset of known malicious prompts to identify and flag suspicious inputs. The no code scanner ensures that no executable code is included in the user queries. The no code scanner evaluates each query for any signs of executable code, such as script tags, code snippets, or command-line instructions. In some embodiments, the no code scanner uses regular expressions and pattern matching techniques to detect and block any code-like structures within the input text. In some embodiments, the no code scanner leverages an allowlist approach, allowing only specific, safe characters and formats to pass through while rejecting anything that deviates from the predefined norms.

The character limit response 408 is a specific type of default response generated by the gameplay assistant when a user's 402 query exceeds the predefined character limit (e.g., 500 characters) when the query is evaluated in the guardrails layer 406. When a query surpasses the limit, the gameplay assistant triggers the character limit response 408, prompting the user 402 to reformulate the user's 402 question (e.g., query) with a shorter message. For example, the prompt includes a message such as, “Your query is too long. Please shorten your message to under 500 characters.” The character limit response 408 maintains the gameplay assistant's performance by reducing the computational load on the subsequent models within the gameplay assistant.

The misbehavior or scanner response 410 is output by the gameplay assistant in response to queries that are deemed inappropriate, off-topic, or potentially harmful (i.e., when the user query has failed one or more scanners in the guardrail layer 406). The misbehavior or scanner response 410 is triggered when the guardrails layer 406 detects issues with the query through various scanning mechanisms (e.g., prompt injection scanner, no code scanner). When such issues are detected, in some embodiments, the misbehavior or scanner response 410 prompts the user 402 to provide additional information or clarification. In some embodiments, the misbehavior or scanner response 410 rejects the query with a message indicating the nature of the problem. For example, if a user 402 submits a query containing offensive language or attempts to manipulate the gameplay assistant, the gameplay assistant generates a response asking the user 402 to reformulate the question in a more appropriate manner.

LLM layer 412 uses one or more text-based LLMs evaluate the query in response queries that have passed the scanners in guardrails layer 406. Upon receiving a user query associated with a specific card interaction or game board state, the LLM layer 412 applies the gameplay rules to simulate or infer the logical outcome of the interaction under the circumstances specified in the query from the users 402. The LLM layer 412 generates an outcome, which constitutes an adjudication of the query, such as a determination of the resulting game state, the resolution of a card effect, or the legality of a proposed action, based on the application of the rules to the circumstances specified in the query.

The LLM layer 412, in some embodiments, generates an explanation that describes a series of steps used to adjudicate the user's query. For example, upon determining the outcome of the card interaction or game board state, an AI model within the LLM layer 412 constructs a step-by-step description that indicates the adjudication dependencies, logical process, rule applications, card interactions, and so forth, in association with the adjudication or gameplay advice. The explanation includes, for example, references to specific gameplay rules, the sequence in which effects or abilities are applied, assumptions or supplemental information used during the adjudication, and so forth. The game application can cause display of a representation of the explanation on the computing device (e.g., the explanation can be presented concurrently with the second outcome).

In some embodiments, the LLM layer 412 determines a first confidence score associated with the generated outcome. The confidence score quantitatively reflects the model's certainty in the correctness and completeness of the adjudication, and is based on factors such as the specificity of the query (i.e., an extent of the adjudication dependencies resolved within the query, as discussed further below), the availability of applicable rules, the degree of alignment with historical rulings, and so forth.

In some embodiments, the LLM layer 412 determines whether the query is appropriate or off-topic by analyzing the content for relevance and adherence to the expected input format. For example, the LLM layer 412 parses the query and compares the query against predefined criteria for acceptable inputs. The criteria include specific keywords, phrases, and syntactic structures that are relevant to the domain of the gameplay assistant (e.g., queries should include a word related to the game aided by the gameplay assistant). For example, if a user asks, “Can I use ‘Counterspell’ to stop ‘Lightning Bolt’?” the LLM layer 412 of a gameplay assistant of the card game Magic will recognize the query as an appropriate query related to card interactions within the game, as the query contains specific card names related to the game and a clear question about the cards' interaction. The LLM layer 412 parses the query, identifies keywords such as “Counterspell” and “Lightning Bolt,” and identifies the context of countering a spell. Conversely, if the LLM layer 412 determines that the query is inappropriate and/or off-topic, the misbehavior or scanner response 410 is output by the gameplay assistant.

The LLM layer 412 assesses the complexity of the query, categorizing the query as either simple or complex based on the intricacy of the card interactions or game board state involved. This categorization is based on predefined rules and patterns recognized by the LLM, which includes, for example, the number of cards involved, the specific abilities of those cards, and the overall game state. The LLM layer 412 evaluates the structure and content of the query, identifying key elements that indicate complexity, such as the number of cards mentioned, the types of interactions described, and the overall context of the game state. In some embodiments, the categorization is based on predefined rules and patterns recognized by the LLM, which include the number of cards involved, the specific abilities of those cards, and the overall game state. The predefined rules and patterns specify, in some embodiments, that queries involving more than a certain number of cards, or those that reference specific complex abilities (like continuous effects or triggered abilities), are categorized as complex. The LLM layer 412 uses the predefined rules and patterns to parse the query and identify the relevant features, comparing them against the predefined criteria to determine the complexity level.

When LLM layer 412 determines that a query is complex, the gameplay assistant triggers the complex question response 414. For example, queries that reference unresolved or highly debated rulings within the game trigger the complex question response 414. Given the complexity and the potential for conflicting interpretations, the gameplay assistant determines that the gameplay assistant cannot provide a definitive answer. In such cases, the complex question response 414 prompts the user 402 with a message indicating that the query is too complex for the gameplay assistant to resolve and, in some embodiments, suggests seeking further clarification from official rulings or experienced judges. The complex question response 414 maintains the accuracy and reliability of the gameplay assistant, ensuring that the gameplay assistant does not provide misleading or incorrect information when faced with highly complex or unresolved scenarios. Methods of evaluating the complexity of a query are discussed with reference to FIG. 5.

If one or more conditions of the interaction referenced by the query remain unsatisfied (e.g., fails to satisfy validation criteria from the set of independent validation models 320a through 320n discussed with reference to FIGS. 3A and 3B), the gameplay assistant generates a follow-up question (e.g., a request for supplemental information). For example, the gameplay assistant determines a sequence of adjudication dependencies for the query whose resolutions are configured to deterministically define an outcome of the card interaction or game board state (or an outcome of a proposed card interaction applied on the current state of the card game in the context of generating gameplay advice). In some embodiments, the gameplay assistant uses a template-based approach, where predefined templates for follow-up questions are stored in a database. For the Humility and Starfield of Nyx interaction referenced, the template used states text such as, “In what order were [Card A] and [Card B] cast?” The gameplay assistant fills in the placeholders with the specific card names involved in the query, resulting in a follow-up question such as “In what order were Humility and Starfield of Nyx cast?”

The request for supplemental information, in some embodiments, identifies one or more adjudication dependencies whose respective resolutions are absent from the query. The respective resolutions of the one or more adjudication dependencies increase the first confidence score. The adjudication dependencies represent specific conditions, parameters, or facts that must be resolved to deterministically define the outcome of the card interaction or game board state referenced in the user's query. For example, the gameplay assistant determines that the order in which two cards entered the battlefield is necessary to resolve a continuous effect interaction, or that the current tapped/untapped status of a card is required to determine combat outcomes.

To determine if one or more conditions (i.e., adjudication dependencies) of the interaction referenced by the query remain unsatisfied, the gameplay assistant uses predefined prompts to identify gaps in the information provided by the user. For example, if a user asks, “Will my ‘Grizzly Bears’ die from my opponent's ‘Savannah Lions’?,” the gameplay assistant checks if all necessary conditions (e.g., whether “Savannah Lions” is able to attack at the particular stage of the game) are met. If not, the gameplay assistant generates a follow-up question like, “Is ‘Savannah Lions’ tapped?” The gaps are identified, in some embodiments, by comparing the user query against the corpus of game rules and card data retrieved by the retrieval layer 420. In some embodiments, custom models are used to determine if one or more conditions remain unsatisfied by using a database of post-executed versions of the game rules. The database contains, for example, game transcripts (e.g., in JSON format) output by digital game platforms. The custom models compare the current game state against the expected conditions (e.g., from the game transcripts) for the interaction.

In some embodiments, the gameplay assistant engages in a multi-turn dialogue by sequentially identifying and resolving multiple adjudication dependencies until the confidence score for adjudicating the query exceeds a predefined threshold (e.g., via a response handler of the game application). Each resolution of an adjudication dependency, i.e., each piece of supplemental information provided by the user, operates to increase the gameplay assistant's generated confidence score, as the ambiguity in the scenario is reduced and the outcome becomes more deterministic.

For example, upon determining that the initial confidence score associated with the first outcome does not exceed a predefined confidence threshold, the game application displays a representation of the request for supplemental information on the user's computing device. The request is presented through a graphical user interface (GUI) element, such as a dialog box, notification, or interactive prompt, to communicate to the user the specific information or clarification required to resolve the outstanding adjudication dependency. The user, in response, is enabled to provide a second input via the computing device, such as by entering text, selecting from predefined options, or uploading relevant images or data, thereby supplying at least a portion of the requested supplemental information, which, in some embodiments, is displayed on the user interface. The LLM layer 412 processes the original query in conjunction with the newly received second input, applying the gameplay rules and card data to generate a second outcome that adjudicates the card interaction or game board state with the benefit of the additional context, and a second confidence score reflecting the model's certainty in the revised adjudication. If the second confidence score exceeds the confidence threshold, the game application causes display of a representation of the second outcome on the computing device, such as by updating the GUI to present the adjudicated result, an explanation of the ruling, or a visual depiction of the updated game state, thereby providing the user with a resolution to the original query.

To generate gameplay advice, upon receiving the command set, the gameplay application determines a sequence of adjudication dependencies for the command set, where the resolutions of these dependencies are configured to deterministically define the outcome of a card interaction or operation applied to the current state of the card game. The gameplay application applies, to the digital representation and/or the command set, an AI model (e.g., the LLM layer 412) trained on the gameplay rules and card data to generate a proposed game operation and an associated confidence metric. When executed by the game application, the proposed game operation causes a change in the digital representation of the card game by applying one or more gameplay rules or card interactions to the current state in accordance with one or more resolutions of the sequence of adjudication dependencies. For example, the proposed game operation alters a card state (for example, changing a card's zone, status, or attributes such as tapped/untapped, power, toughness, or abilities), updates a player resource value (such as adjusting life totals, mana pools, hand size, or other resource counters), changes a game phase indicator (such as advancing the turn, transitioning between phases like main phase or combat phase, or updating priority status), and so forth.

In some embodiments, the game application generates a graphical representation of the proposed game operation that visually depicts the changes or effects resulting from the execution of the operation within the digital representation of the card game. For example, the graphical representation to be output via the user interface of the game application includes animations or visual cues illustrating a card moving from one zone to another (such as from the battlefield to the graveyard), changes in card status (such as a card becoming tapped or untapped), updates to player resource values (such as life totals or mana pools), or transitions between game phases. Upon detecting a change in the digital representation, whether initiated by a user input, an automated game effect, or an external event, the game application automatically triggers the AI model to generate an updated game operation that reflects the new conditions. For example, if a player casts a spell that alters the board state or modifies player resources, the game application recognizes the resulting change and prompts the AI model to determine subsequent rule adjudications or strategic advice.

If the first associated confidence metric fails to satisfy a predefined confidence threshold, the game application generates and presents (e.g., via the computing device) a request for supplemental information in the same or similar manner as described above in the context of rule adjudications. Upon receiving (e.g., via the computing device) a response that includes at least a portion of the requested supplemental information, the game application applies the AI model to the digital representation, the command set, and the supplemental response to generate a revised game operation and a new associated confidence metric. If the new associated confidence metric satisfies the confidence threshold, the game application causes a representation of the revised game operation to be output via a user interface of the game application during gameplay.

In some embodiments, the LLM layer 412 stores the conversation history to maintain context and continuity in ongoing interactions. The LLM layer 412 converts each part of the conversation into vectorized representations using, for example, embeddings generated by transformer models, such as Gemini, which convert text into numerical vectors that capture the semantic meaning and context. The vectors are stored in a structured format, such as an external database or in-memory data structure, allowing the LLM layer 412 to access and reference them as needed. For example, if a user previously asked about the effects of “Humility” and then asks about another card interaction involving “Humility,” the LLM layer 412 references the previous discussion in generating chat response 416 or retrieval-based response 424. The gameplay assistant is able to build on prior interactions and provide more accurate and contextually relevant advice.

In some embodiments, recognized cards (e.g., via computer vision on platforms such as SpellTable) are added to a hidden parameter or RAG elements. Once a card is recognized, the card's details (such as name, type, and attributes) are indexed and stored in a retrievable format within the knowledge base. The structured data is added as a hidden parameter in the query to the AI models. The hidden parameter, while not explicitly specified in user input, enables the model to produce content that adheres to the specific hidden parameter (i.e., and thus accurate to the current game state). In some embodiments, the hidden parameter functions in the same way as a pre-defined query context, further detailed in FIG. 1. Both the pre-defined query context and the hidden parameter guide the generated responses based on predetermined model-driven conditions.

The chat response 416 is output in response to straightforward queries that do not require referencing external data sources. When the LLM layer 412 determines that a query is simple and is able to be answered based on the gameplay assistant's existing knowledge base or stored previous conversations, the gameplay assistant triggers the chat response 416. The chat response 416 allows the LLM layer 412 to handle a high volume of simple queries effectively while reserving more intensive processing resources for complex questions.

The LLM layer 418, retrieval layer 420, and LLM layer 422 form a multi-stage process to evaluate queries using the RAG references in the RAG framework discussed with reference to FIG. 3A. The LLM layer 412 identifies the data sources required to accurately adjudicate the query, such as specific game rules or card data. The LLM layer 412 uses techniques such as entity recognition and context analysis to determine which specific rules or data points are pertinent to the query. Additionally, LLM layer 418 constructs a request (e.g., GraphQL query) from the user's query to fetch relevant card data. For example, if the query involves the interaction between “Humility” and “Starfield of Nyx,” the LLM layer 412 requests the card names, types, text descriptions, mana costs, sets, and any rulings (e.g., how continuous effects are applied in layers) associated with “Humility” and “Starfield of Nyx.”

The retrieval layer 420 fetches relevant data from one or more data sources. The retrieval layer 420 retrieves documents from a database (e.g., BigQuery database) for game rules and uses the request generated by LLM layer 418 to fetch card data from a card services API. For instance, the BigQuery retrieval includes SQL queries to fetch relevant rules, while the card API retrieval executes the GraphQL request to fetch card details.

The LLM layer 422 synthesizes the retrieved data and generates a coherent, comprehensive response 424 using a text-based LLM. For example, the LLM layer 422 explains how “Humility” affects the creatures created by “Starfield of Nyx,” detailing the order in which the effects are applied according to the game rules (e.g., Magic Comprehensive Rules). The generated response 424 states, for example, “Continuous effects are applied in a specific order: first, “Starfield of Nyx” turns all other enchantments into creatures with power and toughness equal to their mana cost; next, “Humility” makes all creatures have a Power of 1 and a Toughness of 1 and removes the creatures' abilities. Thus, all enchantments other than the Starfield of Nyx are creatures with a power of one and toughness of one with no abilities.”

In some embodiments, when the gameplay assistant encounters a query that involves complex interactions the gameplay assistant identifies the need for more specific details to resolve the query accurately. In some embodiments, the gameplay assistant informs subsequent AI model(s) of the specific conditions needed to adjudicate the interaction (e.g., the order in which cards are cast) using RAG references and/or prompt engineering. To learn the specific conditions needed to adjudicate the interaction, the AI model(s) reference a corpus of card rules text (e.g., the full rules text for each card name), allowing the AI model(s) to learn the syntax and semantics of the language used in the game.

For example, in some embodiments, the text is broken down into smaller units (tokens) that the model uses to build a representation of the text while capturing the relationships between different tokens and how the particular tokens contribute to the overall meaning of the text. During training, the AI model(s) are exposed to various examples of card interactions, allowing the AI model(s) to learn patterns and similarities in the rules text. For instance, the AI model(s) learns that phrases like “lose all abilities” and “base power and toughness” are commonly associated with certain types of effects. By recognizing the patterns, the AI model(s) better recognize how different cards interact based on their rules text.

For example, Humility, a card in the card game Magic, is an enchantment where “all creatures lose all abilities and have base power and toughness 1/1.” Starfield of Nyx, another card in the card game Magic, is an enchantment that states, “each other non-Aura enchantment you control is a creature in addition to its other types and has base power and base toughness each equal to its mana value.” The interaction between the two cards depends on the order in which they were cast, as Magic uses a timestamp system to determine the sequence of continuous effects. If the Starfield of Nyx entered first, all enchantments other than the Starfield of Nyx are creatures with a power of one and toughness of one with no abilities. On the other hand, if Humility entered first, all enchantments other than the Starfield of Nyx are creatures with power and toughness equal to the creatures' mana cost with no abilities. The LLM layer 422 learns patterns and similarities from the retrieved rules documents and card data in the retrieval layer 420. For instance, the LLM layer 422 learns that phrases like “lose all abilities” and “base power and toughness” are commonly associated with certain types of game mechanics. The LLM layer 422 also learns that the order of events (e.g., “entered the battlefield first”) requires a further specific condition to be included in the user query (e.g., which card was played first).

In some embodiments, the game application stores, in a memory accessible to the game application, a record of one or more elements associated with the adjudication process, including the original user query, the first outcome generated by the AI model, the first confidence score, any request for supplemental information, the second input provided by the user, the second outcome, and/or the second confidence score. Each record is associated with a user identifier, which is, for example, a unique alphanumeric code, username, or other user-specific attribute. The association enables the gameplay assistant to maintain a persistent history of user interactions. In some embodiments, the stored records are used to improve future adjudications by enabling the AI model (e.g., the LLM layer 412) to reference prior queries and outcomes when generating subsequent adjudications or gameplay advice (e.g., to provide contextually relevant follow-up advice).

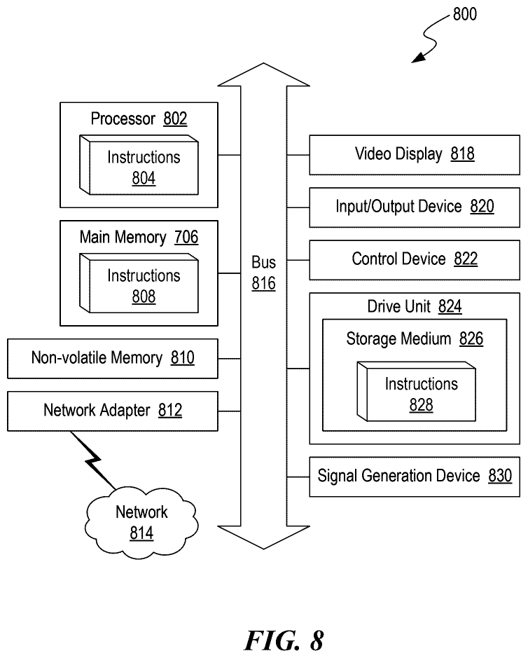

FIG. 5 is a flowchart illustrating an example method 500 (e.g., a computer-implemented method) of adjudicating rules and providing gameplay advice for a card game during gameplay using an AI model. In some embodiments, the method 500 is performed by a gameplay assistant (e.g., the gameplay assistant described with reference to FIG. 4) with components, of example computer system 800 illustrated and described in more detail with reference to FIG. 8. Likewise, implementations can include different and/or additional operations or can perform the operations in different orders.

In operation 502, the gameplay assistant receives, by an AI model, a first query from a user of a computing device. The query is associated with a specific card interaction or game board state of a card game. The query is received through various input methods such as text, images, or video captures. The gameplay assistant uses a chatbot interface for text-based queries, where users type questions. For image or video-based queries (e.g., smartphone-captured images of the field of play or images captured through platforms with live video feeds like SpellTable), the gameplay assistant recognizes and interprets card images and board states from various angles and under different lighting conditions (e.g., using object detection models to localize individual cards and/or segmentation methods to isolate cards from the background).

Using the identified board states, the gameplay assistant identifies timestamps of cards as they are played, providing real-time context for card interactions. For example, when a player captures an image of the battlefield with the user's smartphone, the gameplay assistant uses optical character recognition (OCR) to read the card names and text, and image recognition to identify the card art and layout. This allows the gameplay assistant to accurately determine which cards are in play (i.e., the card identities) and the cards' current state (e.g., the card position). In some embodiments, if a player's camera is slightly tilted or otherwise poor quality, the gameplay assistant adjusts the perspective to straighten the image or otherwise calibrate the image/video data to remove noise. In some embodiments, the query is multimodal. For example, a player uploads a picture of the user's battlefield and asks, “What happens if I cast ‘Wrath of God’ now?” The gameplay assistant identifies all creatures in play from the input image, recognizes the corresponding creatures' current states, and generates a response about the outcome of casting “Wrath of God.”

To train the AI model, which, in some embodiments, are an amalgamation of multiple models (e.g., multiple LLMs) under a single framework, the gameplay assistant uses methods discussed with reference to example architecture 400 in FIG. 4 by retrieving a vector database with vectorized representations of the game rules (e.g., in a .txt format via retrieval layer 420 in FIG. 4), and data retrieved from a card services API for card data (e.g., via retrieval layer 420 in FIG. 4). The gameplay assistant creates the vector database by chunking the game rules into smaller segments and converting them into vector representations using techniques like TF-IDF or word embeddings. In some embodiments, the AI model is trained using supervised learning techniques, where historical query-response pairs are used as training data. The retrieved data provides the system context around rules questions and, in some embodiments, includes meta deck lists (e.g., popular and/or successful card deck configurations used in the game) for opponent predictions. For example, if the player is participating in a game match, the gameplay assistant accesses meta deck lists to predict the opponent's likely deck composition based on current trends to provide strategic advice, such as suggesting potential counterplays or highlighting key cards to watch for.

In operation 504, the gameplay assistant determines, by the AI model, a confidence score associated with adjudicating the first query based on a set of gameplay rules and a set of card data of the card game. The confidence score is a measure of how certain the AI model is about the AI model's ability to provide an accurate response. For instance, if the query involves a well-documented card interaction, the confidence score is high. In some embodiments, the confidence score is calculated using a combination of rule-based logic and machine learning models.

For example, the gameplay assistant identifies, using the AI model, a plurality of candidate outcomes responsive to the query based on the gameplay rules and card data. To identify the candidate outcomes, the gameplay assistant accesses the gameplay rules and card data to enumerate outcomes (e.g., all possible outcomes) based on the specified interaction or state. Each candidate outcome is generated by simulating the application of the gameplay rules to the card data under the current game conditions (e.g., resolving continuous effects, triggered abilities, or replacement effects).

Once the set of candidate outcomes is generated, the gameplay assistant applies the AI model to evaluate each outcome according to a predefined metric. The predefined metric includes, for example, a confidence score reflecting the likelihood that the outcome is correct given the available information, a consistency score measuring alignment with explicit game rulings or historical data, or a relevance score based on the similarity of the current scenario to previously adjudicated cases. The gameplay assistant ranks the candidate outcomes according to the values assigned by the predefined metric (e.g., ordering the outcomes from highest to lowest). In some embodiments, the gameplay assistant applies a weighted combination of multiple metrics to generate a composite score for each outcome. The candidate outcome with the highest value of the predefined metric (or composite score) is selected as the first outcome.

When a user submits a query, the AI model converts the query and the existing data into vectorized representations using techniques like word embeddings or sentence embeddings. The vectors capture the semantic meaning of the text. Cosine similarity calculates the similarity between the vectors by measuring the cosine of the angle between them, with a value of 1 indicating identical vectors (high similarity) and a value of 0 indicating orthogonal vectors (no similarity). The resulting similarity score determines how closely the query matches the existing data. A higher similarity score indicates a higher confidence that the existing data is relevant to the query.

In operation 506, responsive to the first confidence score falling below (or otherwise fails to satisfy) a predefined threshold, the gameplay assistant requests, by the AI model, a second query (i.e., an additional user input) from the computing device associated with the specific card interaction or the game board state of the card game. The confidence score associated with adjudicating the first query and the second query based on the set of gameplay rules and the set of card data of the card game exceeds the predefined threshold. For example, if a user asks about the interaction between two cards, the gameplay assistant (e.g., via a response handler) requests additional details (i.e., supplemental information that is absent from the query and configured to increase the confidence score) such as the order in which the cards were cast (e.g., the timestamp system discussed in FIG. 4).

In operation 508, responsive to the first confidence score exceeding (or otherwise satisfying) the predefined threshold, the gameplay assistant outputs a response adjudicating the first query. The response (e.g., retrieval-based response 424) includes rule adjudications, strategic advice, or both, depending on the nature of the query. For example, based on available mana sources and cards in hand (explicitly provided or obtained from a visual image of the board state), the AI model provides options of what the player is able to perform next or provides a sequencing order for the player's actions. The responses are delivered through the same interface used to receive the queries, such as a chatbot or a GUI. In some embodiments, to generate a response, the gameplay assistant creates predefined templates for common queries, which include placeholders for dynamic content. When a user query is received, the gameplay assistant matches the query to the most appropriate template and populates the placeholders with relevant data retrieved from the database.

To include individual card rulings (e.g., particular interactions between cards), the gameplay assistant includes card rulings as an additional RAG element in the AI model to generate the response. The card rulings are stored as records in a vector database and indexed using techniques like TF-IDF or word embeddings. The gameplay assistant uses similarity measures like cosine similarity to compare the query with the card rulings and retrieve the most relevant card rulings. When the vector distance between relevant card rulings and complex questions is below a predefined threshold, the gameplay assistant assumes that the question and the card rulings align.

For complex queries, the gameplay assistant uses zero shot chain-of-thought prompting by instructing the AI model to break down (e.g., decompose, partition) the query into smaller steps (e.g., sub-queries) and solve each step sequentially. Zero shot refers to the model's ability to handle tasks the model has not been explicitly trained on. For example, if the query is “What are ‘Humility's’ effects if I play it after ‘Starfield of Nyx’?”, the gameplay assistant creates a prompt that instructs the AI model to break down the query into smaller steps, such as explaining the effect of each card and describing the card's interactions. For example, the first step is explaining the effect of “Humility” (an “enchantment” type card that removes card abilities from “creature” type cards) and “Starfield of Nyx,” (a card that makes “enchantment” type cards additionally be “creature” type) the second step is explaining the current board state after playing “Starfield of Nyx,” and the third step is describing the effect of “Humility” on the current board state (e.g., by referencing the timestamp system of the game rules). The above example is a complicated rules interaction because the effects of the cards appear to contradict one another-Humility says creatures have no abilities, but Starfield of Nyx causes Humility to be a creature which should then have no abilities. The rules of the game have a means for resolving the apparent contradiction using a timestamp order. Addressing the issue with a chain-of-thought prompt causes the model to operate using timestamps. The AI model processes each step independently and combines the results to form a final answer.

In another example, some game mechanics specifically replace others. When multiple replacement effects occur simultaneously, a player is able to choose the order of operations. A particular example is an effect that causes resource (e.g., “Mana” or game objects) multiplication or addition. Performing the addition before the multiplication results in a greater final result than if the multiplication is performed first. In addition to a chain-of-thought prompt, the command set further directs the model to make use of a step order that has the greatest benefit for the player who is able to select the order of steps. Thus, for a player with multiple effects that replace resource generation, the order that generates the most resource is used. Conversely, for a player receiving damage that is modified by one or more replacement effects, the order that receives the least damage is used.

In some embodiments, automatic chain-of-thought is used to utilize a database of hand-crafted questions and answers to provide semantically relevant examples. Automatic chain-of-thought refers to the process of automatically retrieving and using pre-existing examples to inform the AI model's response generation. For example, the pre-existing examples include questions and answers that cover a wide range of complex scenarios. Each entry includes a question, an answer, and relevant context. When a complex query is received, NLP techniques are used to find semantically similar questions in the database using vector embeddings and similarity measures like cosine similarity. The most semantically relevant example is retrieved from the database and used to inform the AI model's response generation.

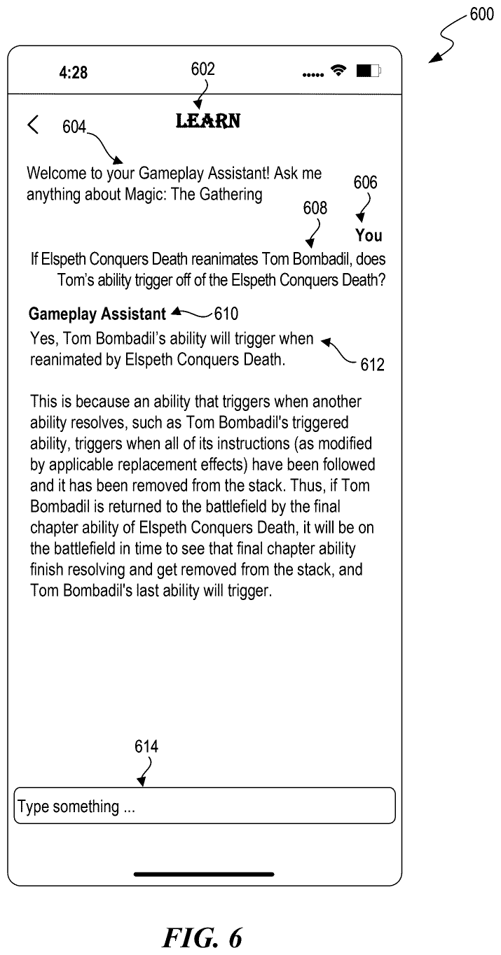

FIG. 6 is a diagram illustrating an example user interface 600 of an AI-based gameplay assistant 602 for a card game. Example user interface 600 includes instructions 604, user indicator 606, user query 608, text field 610, gameplay assistant indicator 612, and gameplay assistant response 614. In some embodiments, implementations of example user interface 600 include different and/or additional components or are connected in different ways.

The instructions 604 guide the user throughout the process of interacting with the gameplay assistant. For example, in FIG. 6, the instructions 604 state, “Welcome to your Gameplay Assistant! Ask me anything about Magic.” In some embodiments, the instructions 604 include criteria on how to submit queries, what kind of information is needed, and how to interpret the responses from the gameplay assistant. For example, the instructions 604 explain how to phrase a query about a specific card interaction or how to upload an image of the game board. In some embodiments, the instructions 604 are interactive, providing real-time feedback as the user types the user's query.

The user indicator 606 identifies the user who is interacting with the gameplay assistant. This indicator helps personalize the experience, ensuring that the responses are tailored to the specific user. For instance, the user indicator displays the user's name or avatar, making the interaction more engaging. The user query 608 is the input provided by the user to seek rule adjudication and strategic advice from the gameplay assistant in the form of text, images, and/or video captures of the game board. For example, a user asks, “If Elspeth Conquers Death reanimates Tom Bombadil, does Tom's ability trigger off of the Elspeth Conquers Death?” or submits a photo of the current game board state (e.g., with the card Elspeth Conquers Death and the card Tom Bombadil from Magic visible) for strategic advice. The text field 610 is the interface element where the user types the query. In some embodiments, as the user types, the text field suggests relevant card names or rules based on the input. In some embodiments, the text field supports multimedia inputs, allowing users to drag and drop images or videos directly into the field, as further discussed with reference to FIG. 5.

While players often use slang terms like “reanimate” to describe returning a card from the graveyard to the battlefield, the official card text and rules do not use this terminology. Thus, though a question is phrased in non-official terms, the gameplay assistant returns a correct answer because the gameplay assistant recognizes that “reanimate” refers to the action of returning a card from the graveyard to the battlefield, even though the official term used in the card text is “return.” In some embodiments, the gameplay assistant uses fuzzy matching to compare strings (i.e., lines of text) containing the question and the official card/rule text. For example, the gameplay assistant uses a fuzzy matching algorithm, such as the Levenshtein distance, which measures the number of single-character edits (insertions, deletions, or substitutions) used to change one word (e.g., “reanimate”) into another (e.g., “return”). If the calculated distance is below a certain threshold, the terms are considered a match, where the threshold is set based on the acceptable level of similarity for the specific application.

In some embodiments, to improve the accuracy of identifying slang, the gameplay assistant measures context-based similarity metrics. For example, the gameplay assistant uses cosine similarity to compare the vector representations of the terms “reanimate” and “return” within the terms' respective contexts (e.g., the user query and the official rules/card text). If “reanimate” is used in a context involving graveyards and battlefields, and “return” frequently appears in similar contexts within the official rules, the model maps “reanimate” to “return.” To map the terms, the gameplay assistant compares a vector representation of the user query that contains slang, or other colloquial expressions absent from the official gameplay rules or card text, and a vector representation of the official rules text that contains the official wording and measures proximity between the vector representations (e.g., cosine similarity). If the cosine similarity score is high, the cosine similarity indicates that the vector representations of the user query and the official rules/card text are closely aligned, meaning that the terms are used in similar contexts. The gameplay assistant (e.g., via the game application) modifies the original query by replacing the slang terminology with the mapped official game terms to standardize the query format. The modified query is subsequently transmitted to the LLM layer 412 for adjudication.

The gameplay assistant indicator 612 is a visual cue, such as a name (e.g., “Gameplay Assistant”) or picture that appears on the user interface 600 to indicate the response. The gameplay assistant response 614 is the output generated by the gameplay assistant in response to the user's query (e.g., rule adjudications, strategic advice). For example, the gameplay assistant response 614 provides a rule adjudication such as, “Yes, Tom Bombadil's ability will trigger when reanimated by Elspeth Conquers Death.” In some embodiments, the gameplay assistant response 614 additionally explains the reasoning behind the rule adjudication, such as how a specific card interaction works and/or referencing a particular game rule. For example, the gameplay assistant response 614 in FIG. 6 explains that since “an ability that triggers when another ability resolves . . . triggers when all of its instructions (as modified by applicable replacement effects) have been followed and it has been removed from the stack,” Tom Bombadil's ability will trigger when reanimated by Elspeth Conquers Death. In some embodiments, the gameplay assistant response 614 is interactive, allowing users to ask follow-up questions or request additional clarification, as further discussed with reference to FIG. 4 and FIG. 5.

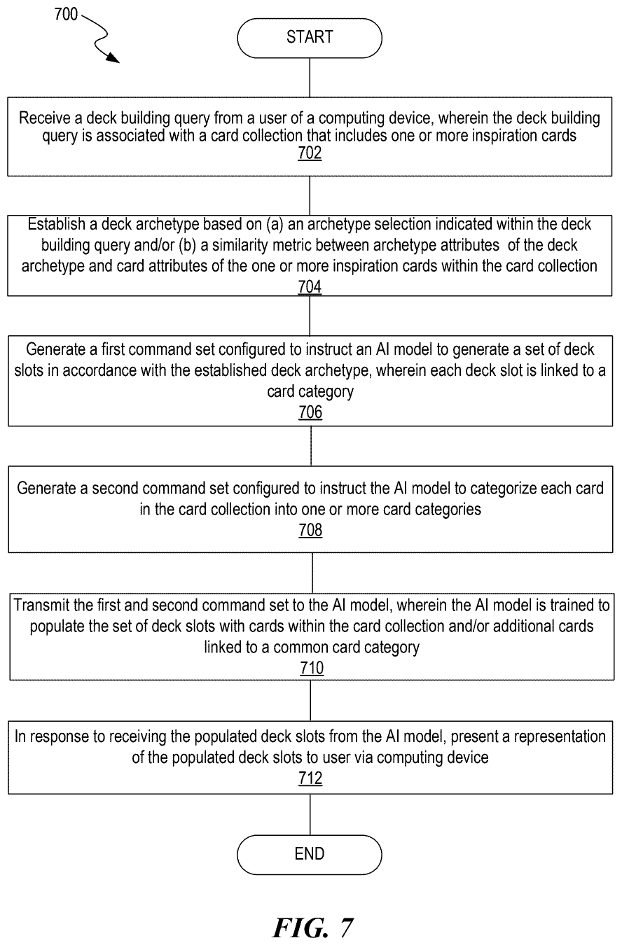

FIG. 7 is a flowchart illustrating an example method of suggesting deck construction (i.e., constructing, determining, and/or selecting card deck lists of a card game) based on one or more inspiration cards. Deck construction, at a level that is useful for a novice player, may employ a number of heuristics. In step 702, the gameplay assistant receives a deck building query from a user interface of a computing device, where the deck building query is associated with a card collection that includes one or more reference (i.e., inspiration) cards. For example, a user provides a list of cards in their collection or cards that they have available for deck building. Embodiments of that list originate from a digital client card collection (e.g., Magic Online or Magic Arena), data from a retailer's website, data from a collection management website (e.g., Scryfall, Moxfield, Archidekt), or data from manual entry. In addition to the collection, the initial query may include one or more inspiration cards. The inspiration card(s) indicate that the user wants to include that card in the deck list the gameplay assistant (i.e., the game platform) generates.

In step 704, the gameplay assistant establishes a deck archetype based on an archetype selection (e.g., a user selection) indicated within the deck building query and/or a similarity metric between archetype attributes (e.g., a card type distribution, a mana curve characteristic, a gameplay function characteristic, a playstyle indicator, a deck list format, or a keyword) of the deck archetype and card attributes (e.g., a card type, a keyword, or a playstyle indicator) of the one or more reference cards within the card collection. Archetype attributes include, for example, card type distributions (e.g., percentage of creatures versus spells), mana curve characteristics (e.g., average and distribution of game resource costs), gameplay function characteristics (e.g., proportion of removal, resource generation, or card advantage cards), color composition, deck list formats (e.g., “Standard” or “Commander”), and/or archetype-specific strategic keywords or playstyle tags derived from historical meta decks or pre-defined templates. Card attributes include, for example, card type (e.g., creature, spell, land, artifact), keywords (e.g., “destroy,” “counter,” “draw,” “damage”), mana cost, color identity, playstyle indicators (e.g., aggressive, control-oriented, combo-enabling, proactive, reactive), and so forth.

For example, the user indicates what sort of deck they are interested in building. As mentioned above, in an embodiment configured for novice players, some high-level guidance for deck archetypes is applicable. For example, an indication that the user seeks a deck that is one of: a control deck (employing reactive strategies), an aggro deck (employing proactive strategies that seek to expend resources quickly), or a mid-range deck (employing proactive strategies that seek to establish a dominant position of cards in play). Through the use of the inspiration cards and deck archetype selection, the gameplay assistant is instructed to use a template for the selected deck archetype and insert the inspiration card(s) into that template. In some embodiments, the format of the deck is assumed (e.g., the “Standard” format). In some embodiments, the format is player selected, or imputed from the card collection (e.g., determine whether the card collection's legality all falls within a certain subset of formats).

In some embodiments, the gameplay assistant, via implementation of NLP task(s) as discussed elsewhere in this application, identifies the card attributes of each card in the card collection. The NLP tasks include parsing the card text, metadata, and/or associated descriptive information to extract the card attributes. In some embodiments, the extracted attributes are aggregated across the card collection to generate a composite attribute profile representing the overall strategic and functional characteristics of the user's available cards and any specified inspiration cards. The gameplay assistant compares the composite attribute profile of the card collection against a set of predefined deck archetype profiles. To determine the most appropriate deck archetype, the gameplay assistant computes a similarity metric (such as cosine similarity, Jaccard index, or other vector-based or statistical comparison) between the card attribute vector of the user's card collection and each archetype profile. The archetype profile with the highest similarity score is selected as the recommended deck archetype.

In cases where the deck building query includes an explicit archetype parameter or selection, the gameplay assistant prioritizes, in some embodiments, the user-specified archetype. The gameplay assistant, in some embodiments, generates and provides feedback or alternative suggestions if the card collection exhibits a stronger alignment (i.e., a higher similarity metric value) with a different archetype based on the determined similarity. Thus, the gameplay assistant is enabled to generate deck-building recommendations, even for novice users who may not be familiar with archetype terminology or different deck construction strategies.

To establish the deck archetype, the gameplay assistant, in some embodiments, retrieves, via implementation of a RAG database as discussed elsewhere in this application, one or more meta deck lists from an external database and/or a third-party (e.g., external) website. The RAG database interfaces with data sources, including but not limited to, online repositories of competitive deck lists, community-curated meta-analyses, official or unofficial card game platforms (e.g., MTGGoldfish, Scryfall, Moxfield, or similar services), and the like. The gameplay assistant transmits structured queries (e.g., API calls, web scraping routines, or database queries) to retrieve meta deck lists that reflect current trends, popular archetypes, and/or successful strategies within the game's competitive or gameplay environment.

Upon retrieval, the gameplay assistant parses the meta deck lists (e.g., via implementation of NLP task(s) as discussed elsewhere in this application) to extract archetype-defining features (i.e., the archetype attributes) and store the archetype-defining features in the RAG database, where the features are indexed and thus available for comparisons against the user's card collection and any specified inspiration cards. Associated metadata, such as deck performance statistics, tournament results, or user ratings are stored alongside the archetype-defining features in the RAG database, in some embodiments.

To enable the above steps to operate, a command set for an AI model includes instructions (via structured command sets) to seek answers through a user interface (e.g., through a combination of any of a chat interface, a game client interface, or an account management interface). In step 706, the gameplay assistant generates a first command set that directs (e.g., instructs) the AI model to generate a set of deck slots (i.e., a deck template) in accordance with the established deck archetype, wherein each deck slot is linked to a card category. The sought answers include enough information to programmatically identify the deck template to use.

In some embodiments, the first command set is structured to elicit from the user, either explicitly or implicitly, the information used to programmatically identify the deck template. The first command set includes, for example, prompts or queries regarding the user's preferred playstyle, desired deck archetype, format constraints (such as “Standard,” “Modern,” “Commander,” etc.), color preferences, specific inspiration cards, strategic goals, and so forth. In some embodiments, the user interface presents prompts in a conversational flow, a guided form, or as selectable options. Each deck slot within the template is programmatically linked to a specific card category, such as “early-game threats,” “removal spells,” “card draw,” “resource generation,” “top-end finishers,” “lands,” and so forth. The number and type of slots are determined based on archetype-specific heuristics, meta data, and/or predefined best practices for the selected format and playstyle.

In some embodiments, the gameplay assistant “second guesses” the user by identifying ambiguities, inconsistencies, or otherwise sub-optimal choices. For example, if a user selects an archetype that is not supported by their available card pool, or if the chosen inspiration cards do not align with the selected deck archetype, the gameplay assistant prompts the user with clarifying questions, alternative suggestions, and/or warnings about potential mismatches. The assistant, in some embodiments, recommends more suitable archetypes (i.e., archetypes with a higher metric value), card substitutions, or deck configurations based on meta data, best practices, or observed trends among similar users.

In some embodiments, the AI model generates one or more modifications to the one or more meta deck lists based on the card collection and a degree of similarity between the card collection and the one or more meta deck lists. For each meta deck list, the AI model determines which cards from the meta deck are present in the user's collection and which are missing. The AI model generates proposed modifications by substituting unavailable cards with functionally similar alternatives from the user's collection. In some embodiments, the AI model prioritizes replacements that maintain the original deck's archetype-defining attributes (e.g., mana curve, color identity, card type distribution, and functional attributes (e.g., removal, card draw, win conditions)). In generating the modifications, the AI model, in some embodiments, adjusts the overall deck composition to account for the user's available resources, such as reducing the number of colors if the user lacks sufficient multi-color mana sources, or rebalancing the deck's mana curve to fit the available card pool.

If the meta deck data provides a high-confidence match (e.g., a similarity metric value above a certain threshold), the AI model uses the corresponding archetype as the established archetype. However, if the analysis yields a weak or ambiguous match (e.g., a similarity metric value below a certain threshold), the AI model is instructed to refrain from forcing an archetype assignment. Instead, the first command set includes instructions for the AI model to prompt the user for additional input or default to a more flexible, general-purpose deck template. Thus, the gameplay assistant reduces the risk of misclassifying the user's intent or constructing a deck list based on uncertain or incomplete meta information.

In step 708, the gameplay assistant generates a second command set that directs (e.g., instructs) the AI model to categorize each card in the card collection into one or more card categories based on a function, a card effect, or a keyword of the card. For example, the second command set, which is a parallel command set, is generated for the AI model that seeks categorization of the cards of the provided card collection. The categorization sorts the cards in the collection into similar effects. Illustrative examples of such categories include “resources/lands”, “removal/interaction cards”, “card advantage cards”, “top-end threat cards”, “early threat cards”, “board wipe cards,” “resource advantage cards.” For example, a card with the text “destroy target creature” may be classified under the “removal/interaction” category, while a card that enables a player to draw additional cards may be sorted into the “card advantage” category. Cards may be assigned to multiple categories if they fulfill more than one strategic function (e.g., a creature that both presents significant combat power and provides card draw). Each deck list template, based on the archetype that template fits into, includes slots dedicated to these categories.

Sorting cards into the categories is performed via implementation of a RAG database as discussed elsewhere in this application. When a card collection is received, the gameplay assistant queries the RAG database to retrieve information associated with each card, such as official card text, type, mana cost, keywords, and/or historical usage data. The RAG database interfaces with, for example, external sources such as community-maintained wikis, official card databases, or third-party analytics platforms, to support its internal knowledge base.

The card categorization may be performed on a collection basis, where the AI model assigns the cards to categories based on their individual attributes and roles within the deck, or on a card-set basis, where the AI model uses a pre-existing knowledge base, such as a RAG database, that stores metadata and/or functional classifications for all cards in a given set. A card set refers to a curated collection of cards that are typically released together as a unified product within a collectible card game. Each card set, for example, is associated with a distinct theme, storyline, or mechanical focus. By referencing the RAG database, the AI model identifies the typical function of each card in the collection based on a card set associated with each card.

In step 710, the gameplay assistant transmits the first and second command set to the AI model. In some embodiments, the delivery of the first and second command sets is concurrent. In other embodiments, the second command set is transmitted asynchronously either before the first command set, or on an ongoing basis. The AI model is trained to populate the set of deck slots (e.g., the deck template) with cards within the card collection (e.g., cards available) and/or additional cards (e.g., suggested cards) different from the cards within the card collection, linked to a common card category. For example, the AI model is instructed, via the first and/or second command set, to fill the corresponding deck template with cards from the collection and the inspiration card(s) if any.

In some embodiments, the AI model's command set is tuned to address a number of factors in the card selection to fill out the deck list template. Examples of those factors include the number of colors the deck should support (e.g., typically 1 or 2 colors while configured for novices). Another factor is included in the command set content addresses a “mana curve” or a resource cost distribution that corresponds to the chosen archetype (e.g., aggro decks will have the lowest mana curve and the fewest land cards). Mana curve is further applicable to categories within the card collection (e.g., removal/interaction cards are preferred to require fewer resources than other categories).

In response to determining that one or more deck slots are unpopulated, in some embodiments, the AI model recommends one or more additional cards different from the cards in the card collection based on a respective card category of the unpopulated deck slot and the established deck archetype. For example, in cases where the user's collection lacks sufficient cards to fill all deck slots for a given category (e.g., not enough removal spells or mana sources), the AI model is directed to suggest additional cards that are drawn from a broader database of available cards and fulfill the same or similar functional role and maintain the archetype attributes of the deck's archetype.

In some embodiments, the AI model indicates unfillable holes. If certain slots remain unfillable (i.e., the user's collection and/or the suggestion pool do not contain matching candidates for a required category), the AI model explicitly indicates the unfillable holes in the output. For example, the gameplay assistant prompts the user with recommendations for potential card acquisitions to resolve the gaps, or provide alternative deck configurations based on the user's current collection.

In response to determining that the populated set of deck slots excludes a particular inspiration card, in some embodiments, the AI model generates an explanation describing the exclusion of the particular reference card within the populated set of deck slots. The explanation includes a rationale based on the deck archetype, card category requirements, and so forth. For example, the AI model identifies that the inspiration card does not fit the established deck archetype due to incompatible color identity, excessive mana cost, or a lack of synergy with other cards in the deck. The AI model is enabled to reference specific constraints, such as a maximum number of cards allowed in a given category, format legality, or redundancy with other included cards. In some embodiments, the explanation is presented to the user through the GUI as a contextual message or tooltip.

In some embodiments, the AI model generates buy recommendations, which are specific suggestions for cards that the user may consider acquiring to increase alignment with the established deck archetype and/or to complete a required deck configuration specified by the established deck archetype. The buy recommendations are generated based on factors such as the established deck archetype, current meta-game trends (as determined by RAG databases that interface with third-party databases or websites), card interactions, mana curve balance, and format legality. The recommendations are presented to the user through the GUI, and in some embodiments, accompanied by contextual explanations such as, “Adding Card X will improve your deck's early-game presence,” or “Card Y is popular with users playing this archetype.” In some embodiments, the gameplay assistant presents, via the GUI, direct links to online retailers, marketplaces, or collection management tools, to enable users to conveniently access particular sites to purchase or trade for the recommended cards.

In step 712, in response to receiving the populated set of deck slots from the AI model, the gameplay assistant presents a representation of the populated set of deck slots to the user interface of the computing device. In some embodiments, the gameplay assistant includes a GUI component that enables users to automatically transition from deck construction to gameplay. Once the AI model has generated and presented the completed deck list, the GUI displays an interactive element, such as a “Play Now” or “Start Game” button. By selecting this option, users are enabled to load the newly constructed deck into a compatible digital game client or simulation environment without the need for manual export, import, or additional configuration steps (which cause additional loading screens, interactions from the user, and so forth). The GUI thereby reduces user interface (UI) hang (i.e., UI freeze) and latency by reducing the number of screens and interactions to move from deck building to active gameplay. For example, the gameplay assistant pre-fetches game assets in the background while the user reviews the deck, thereby reducing perceived wait times. The gameplay assistant enables a more efficient use of screen real estate and computational resources.

### Computing Platform

FIG. 8 is a block diagram illustrating an example computer system 800, in accordance with one or more embodiments. In some embodiments, components of the example computer system 800 are used to implement the software platforms described herein. At least some operations described herein can be implemented on the computer system 800.

In some embodiments, the computer system 800 includes one or more central processing units (“processors”) 802, main memory 806, non-volatile memory 810, network adapters 812 (e.g., network interface), video displays 818, input/output devices 820, control devices 822 (e.g., keyboard and pointing devices), drive units 824 including a storage medium 826, and a signal generation device 820 that are communicatively connected to a bus 816. The bus 816 is illustrated as an abstraction that represents one or more physical buses and/or point-to-point connections that are connected by appropriate bridges, adapters, or controllers. The bus 816, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 894 bus (also referred to as “Firewire”).

In some embodiments, the computer system 800 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 800.

While the main memory 806, non-volatile memory 810, and storage medium 826 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 828. The term “machine-readable medium” and “storage medium” shall also be taken to include any medium that is capable of storing, encoding, or carrying a set of instructions for execution by the computer system 800. In some embodiments, the non-volatile memory 810 or the storage medium 826 is a non-transitory, computer-readable storage medium storing computer instructions, which is executable by the one or more “processors” 802 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 804, 808, 828) set at various times in various memory and storage devices in a computer device. When read and executed by the one or more processors 802, the instruction(s) cause the computer system 800 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory 810 devices, floppy and other removable disks, hard disk drives, optical discs (e.g., compact disc read-only memory (CD-ROMS), digital versatile discs (DVDs)), and transmission-type media such as digital and analog communication links.

The network adapter 812 enables the computer system 800 to mediate data in a network 814 with an entity that is external to the computer system 800 through any communication protocol supported by the computer system 800 and the external entity. The network adapter 812 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 812 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

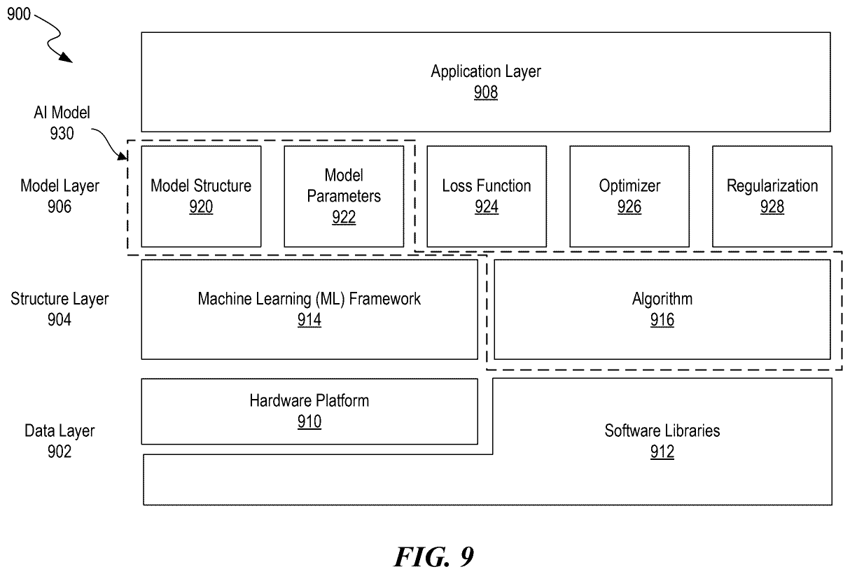

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 900 illustrated and described in more detail with reference to FIG. 9.

### AI System

FIG. 9 is a high-level block diagram illustrating an example AI system, in accordance with one or more embodiments. The AI system 900 is implemented using components of the example computer system 800 illustrated and described in more detail with reference to FIG. 8. Likewise, embodiments of the AI system 900 include different and/or additional components or be connected in different ways.

In some embodiments, as shown in FIG. 9, the AI system 900 includes a set of layers, which conceptually organize elements within an example network topology for the AI system's architecture to implement a particular AI model 930. Generally, an AI model 930 is a computer-executable program implemented by the AI system 900 that analyses data to make predictions. Information passes through each layer of the AI system 900 to generate outputs for the AI model 930. The layers include a data layer 902, a structure layer 904, a model layer 906, and an application layer 908. The algorithm 916 of the structure layer 904 and the model structure 920 and model parameters 922 of the model layer 906 together form the example AI model 930. The optimizer 926, loss function engine 924, and regularization engine 928 work to refine and optimize the AI model 930, and the data layer 902 provides resources and support for the application of the AI model 930 by the application layer 908.

The data layer 902 acts as the foundation of the AI system 900 by preparing data for the AI model 930. As shown, in some embodiments, the data layer 902 includes two sub-layers: a hardware platform 910 and one or more software libraries 912. The hardware platform 910 is designed to perform operations for the AI model 930 and includes computing resources for storage, memory, logic, and networking, such as the resources described in relation to FIG. 3A and FIG. 3B. The hardware platform 910 processes amounts of data using one or more servers. The servers can perform backend operations such as matrix calculations, parallel calculations, machine learning (ML) training, and the like. Examples of servers used by the hardware platform 910 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 910 includes Infrastructure as a Service (IaaS) resources, which are computing resources, (e.g., servers, memory, etc.) offered by a cloud services provider. In some embodiments, the hardware platform 910 includes computer memory for storing data about the AI model 930, application of the AI model 930, and training data for the AI model 930. In some embodiments, the computer memory is a form of random-access memory (RAM), such as dynamic RAM, static RAM, and non-volatile RAM.

In some embodiments, the software libraries 912 are thought of as suites of data and programming code, including executables, used to control the computing resources of the hardware platform 910. In some embodiments, the programming code includes low-level primitives (e.g., fundamental language elements) that form the foundation of one or more low-level programming languages, such that servers of the hardware platform 910 can use the low-level primitives to carry out specific operations. The low-level programming languages do not require much, if any, abstraction from a computing resource's instruction set architecture, allowing them to run quickly with a small memory footprint. Examples of software libraries 912 that can be included in the AI system 900 include Intel Math Kernel Library, Nvidia cuDNN, Eigen, and Open BLAS.

In some embodiments, the structure layer 904 includes an ML framework 914 and an algorithm 916. The ML framework 914 can be thought of as an interface, library, or tool that allows users to build and deploy the AI model 980. In some embodiments, the ML framework 914 includes an open-source library, an API, a gradient-boosting library, an ensemble method, and/or a deep learning toolkit that works with the layers of the AI system facilitate development of the AI model 930. For example, the ML framework 914 distributes processes for the application or training of the AI model 930 across multiple resources in the hardware platform 910. In some embodiments, the ML framework 914 also includes a set of pre-built components that have the functionality to implement and train the AI model 930 and allow users to use pre-built functions and classes to construct and train the AI model 930. Thus, the ML framework 914 can be used to facilitate data engineering, development, hyperparameter tuning, testing, and training for the AI model 930. Examples of ML frameworks 914 that can be used in the AI system 900 include TensorFlow, PyTorch, Scikit-Learn, Keras, Caffe, LightGBM, Random Forest, and Amazon Web Services.

In some embodiments, the algorithm 916 is an organized set of computer-executable operations used to generate output data from a set of input data and can be described using pseudocode. In some embodiments, the algorithm 916 includes complex code that allows the computing resources to learn from new input data and create new/modified outputs based on what was learned. In some embodiments, the algorithm 916 builds the AI model 930 through being trained while running computing resources of the hardware platform 910. The training allows the algorithm 916 to make predictions or decisions without being explicitly programmed to do so. Once trained, the algorithm 916 runs at the computing resources as part of the AI model 930 to make predictions or decisions, improve computing resource performance, or perform tasks. The algorithm 916 is trained using supervised learning, unsupervised learning, semi-supervised learning, and/or reinforcement learning.

The application layer 908 describes how the AI system 900 is used to solve problems or perform tasks. In an example implementation, the application layer 908 includes the response generator 316.

As an example, to train an AI model 930 that is intended to model human language (also referred to as a language model), the data layer 902 is a collection of text documents, referred to as a text corpus (or simply referred to as a corpus). The corpus represents a language domain (e.g., a single language), a subject domain (e.g., scientific papers), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 902 is annotated with ground truth labels (e.g., each data entry in the training dataset is paired with a label), or unlabeled.

Training an AI model 930 generally involves inputting into an AI model 930 (e.g., an untrained ML model) data layer 902 to be processed by the AI model 930, processing the data layer 902 using the AI model 930, collecting the output generated by the AI model 930 (e.g., based on the inputted training data), and comparing the output to a desired set of target values. If the data layer 902 is labeled, the desired target values, in some embodiments, are, e.g., the ground truth labels of the data layer 902. If the data layer 902 is unlabeled, the desired target value is, in some embodiments, a reconstructed (or otherwise processed) version of the corresponding AI model 930 input (e.g., in the case of an autoencoder), or is a measure of some target observable effect on the environment (e.g., in the case of a reinforcement learning agent). The parameters of the AI model 930 are updated based on a difference between the generated output value and the desired target value. For example, if the value output by the AI model 930 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 930 typically is to minimize a loss function or maximize a reward function.

In some embodiments, the data layer 902 is a subset of a larger data set. For example, a data set is split into three mutually exclusive subsets: a training set, a validation (or cross-validation) set, and a testing set. The three subsets of data, in some embodiments, are used sequentially during AI model 930 training. For example, the training set is first used to train one or more ML models, each AI model 930, e.g., having a particular architecture, having a particular training procedure, being described by a set of model hyperparameters, and/or otherwise being varied from the other of the one or more ML models. The validation (or cross-validation) set, in some embodiments, is then used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (i.e., with the training set) begins again on a different ML model described by the new set of determined hyperparameters. These steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model's accuracy. Other segmentations of the larger data set and/or schemes for using the segments for training one or more ML models are possible.

Backpropagation is an algorithm for training an AI model 930. Backpropagation is used to adjust (also referred to as update) the value of the parameters in the AI model 930, with the goal of optimizing the objective function. For example, a defined loss function is calculated by forward propagation of an input to obtain an output of the AI model 930 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 930 are used. The process of updating (or learning) the parameters over many iterations is referred to as training. In some embodiments, training is carried out iteratively until a convergence condition is met (e.g., a predefined maximum number of iterations has been performed, or the value output by the AI model 930 is sufficiently converged with the desired target value), after which the AI model 930 is considered to be sufficiently trained. The values of the learned parameters are then fixed and the AI model 930 is then deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 930 typically involves further training the ML model on a number of data samples (which may be smaller in number/cardinality than those used to train the model initially) that closely target the specific task. For example, an AI model 930 for generating natural language that has been trained generically on publicly available text corpora is, e.g., fine-tuned by further training using specific training samples. In some embodiments, the specific training samples are used to generate language in a certain style or a certain format. For example, the AI model 930 is trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

In some embodiments, the language model uses a neural network (typically a DNN) to perform NLP tasks. A language model is trained to model how words relate to each other in a textual sequence, based on probabilities. In some embodiments, the language model contains hundreds of thousands of learned parameters, or in the case of a large language model (LLM) contains millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text inputs). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model's theory of operation has been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL and GPT-type models are language models that are considered to be decoder-only language models.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some embodiments, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt, which is a natural language input that includes instructions to the LLM to generate a desired output. In some embodiments, a computer system generates a prompt that is provided as input to the LLM via the LLM's API. As described above, the prompt is processed or pre-processed into a token sequence prior to being provided as input to the LLM via the LLM's API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, the llama2 is used as a large language model, which is a large language model based on an encoder-decoder architecture, and can simultaneously perform text generation and text understanding. The llama2 selects or trains proper pre-training corpus, pre-training targets and pre-training parameters according to different tasks and fields, and adjusts a large language model on the basis so as to improve the performance of the large language model under a specific scene.

In some embodiments, the Falcon40B is used as a large language model, which is a causal decoder-only model. During training, the model predicts the subsequent tokens with a causal language modeling task. The model applies rotational positional embeddings in the model's transformer model and encodes the absolution positional information of the tokens into a rotation matrix.

In some embodiments, the Claude is used as a large language model, which is an autoregressive model trained on a large text corpus unsupervised.

### EXAMPLES

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples can be combined in any suitable manner, and placed into a respective independent example. The other examples can be presented in a similar manner.
1. A computer-implemented method for adjudicating rules during gameplay of a card game using artificial intelligence (AI), the computer-implemented method comprising:
receiving, via a computing device configured to execute a game application, a first input that includes a query associated with a card interaction or game board state of the card game, wherein the card game is defined by gameplay rules that are applied to card data;
determining a sequence of adjudication dependencies for the query whose resolutions are configured to deterministically define an outcome of the card interaction or game board state;
transmitting, using the game application, the query into an AI model trained to:
   generate (a) a first outcome of the card interaction or the game board state that adjudicates the query in accordance with the gameplay rules and the card data and (b) a first confidence score associated with the first outcome, and
   in response to a determination that the first confidence score is below a confidence threshold, generate a request for supplemental information that identifies one or more adjudication dependencies whose respective resolutions are absent from the query, wherein the respective resolutions of the one or more adjudication dependencies are configured to increase the first confidence score;
causing display of, using the game application, a representation of the request on the computing device;
receiving, via the computing device, a second input that identifies at least a portion of the supplemental information;
generating, using the AI model, (a) a second outcome of the card interaction or the game board state that adjudicates the query in accordance with the gameplay rules, the card data, and the second input, and (b) a second confidence score associated with the second outcome; and
in response to a determination that the second confidence score exceeds the confidence threshold, causing display of a representation of the second outcome on the computing device.
2. The computer-implemented method of example 1, further comprising:
identifying, by the game application, a plurality of candidate outcomes responsive to the query based on the gameplay rules and card data;
ranking the plurality of candidate outcomes using the AI model based on a predefined metric; and
selecting, as the first outcome, a particular candidate outcome having a highest value of the predefined metric.
3. The computer-implemented method of example 1, further comprising:
storing, in a memory accessible to the game application, a record of one or more of the queries, the first outcome, the first confidence score, the request for the supplemental information, the second input, the second outcome, or the second confidence score; and
associating the record with a user identifier.
4. The computer-implemented method of example 1, further comprising:
generating, using the AI model, an explanation that describes a series of steps used to adjudicate the query; and
causing display of a representation of the explanation on the computing device concurrently with the second outcome.
5. The computer-implemented method of example 1, further comprising:
determining, by the game application, that the query includes slang terminology absent from the gameplay rules;
mapping the slang terminology one or more game terms present in the gameplay rules; and
modifying the query to replace the slang terminology with the one or more game terms prior to transmitting the query to the AI model.
6. The computer-implemented method of example 1, further comprising:
receiving, by the game application, an image or video of the game board state as a portion of the first input;
identifying query context that includes at least one of card identities or card positions from the image or video; and
transmitting the query context to the AI model.
7. The computer-implemented method of example 1, further comprising:
decomposing the query into a sequence of sub-queries based on the gameplay rules and the card data, wherein each sub-query identifies the adjudication dependencies; and
sequentially transmitting, using the game application, the sequence of sub-queries into the AI model.
8. A computer-implemented method for generating gameplay advice during gameplay using artificial intelligence (AI), the computer-implemented method comprising:
executing, via a computing device, a game application that maintains a digital representation of a current state of a card game, wherein the card game is defined by gameplay rules that are applied to card data, and wherein the digital representation identifies one or more of current card attributes, player resources, or game phase information;
receiving, via the computing device, a command set for a generation of a game operation based on the digital representation;
determining a sequence of adjudication dependencies for the command set whose resolutions are configured to deterministically define an outcome of a card interaction applied on the current state of the card game;
applying, to (a) the digital representation and (b) the command set, an AI model trained on the gameplay rules and the card data to generate (a) a proposed game operation and (b) a first associated confidence metric, wherein the proposed game operation is configured to, when executed by the game application, cause a change in the digital representation of the card game by applying the card interaction to the current state of the card game in accordance one or more resolutions of the sequence of adjudication dependencies;
in response to determining that the first associated confidence metric fails to satisfy a confidence threshold, generating, via the game application, a request for supplemental information that identifies one or more adjudication dependencies whose respective resolutions are absent from the command set, wherein the respective resolutions of the one or more adjudication dependencies are configured to increase the first associated confidence metric;
receiving, via the computing device, a response comprising at least a portion of the supplemental information;
applying, to (a) the digital representation and (b) the command set, and (c) the response, the AI model to generate (a) a revised game operation and (b) a second associated confidence metric, wherein the second associated confidence metric satisfies the confidence threshold; and
causing, via the computing device, a representation of the revised game operation to be output via a user interface of the game application during gameplay.
9. The computer-implemented method of example 8, wherein the proposed game operation is configured to, when executed by the game application, modify at least one of a card state, a player resource value, or a game phase indicator in accordance with the gameplay rules.
10. The computer-implemented method of example 8, further comprising:
generating a graphical representation of the proposed game operation; and
causing the graphical representation to be output via the user interface.
11. The computer-implemented method of example 8, further comprising:
receiving, by the game application, a user selection of the revised game operation; and
updating the digital representation of the card game by executing the revised game operation.
12. The computer-implemented method of example 8, further comprising:
detecting, by the game application, a change in the digital representation during gameplay; and
automatically generating, using the AI model, an updated game operation based on the change.
13. The computer-implemented method of example 8, further comprising:
prior to outputting the revised game operation via the user interface, validating the revised game operation using a plurality of independent validation models, wherein each validation model is configured to assess a different attribute of the revised game operation according to a respective pre-loaded query context of each validation model.
14. The computer-implemented method of example 13, wherein the command set is generated subsequent to a determination generated using a particular validation model, wherein the determination indicates that the revised game operation fails to satisfy the respective pre-loaded query context of the particular validation model.
15. A game application for providing virtual gameplay assistance during gameplay of a game using artificial intelligence (AI), comprising:
a user interface instantiated by the game application on a computing device and configured to receive user input that requests gameplay assistance based on a state of the game indicated in the user input;
a data access interface of the game application that is configured to retrieve, from a memory accessible to the game application, a data structure representing a current configuration of the game, wherein the data structure identifies information corresponding to gameplay rules and game data;
a communication interface of the game application that is configured to:
   determine a sequence of adjudication dependencies for the user input whose resolutions are configured to deterministically define one or more outcomes of one or more game operations applied on the state of the game, and
   transmit the data structure and the user input to a trained AI model trained to generate a proposed response and an associated validation metric value by applying the one or more game operations on the state of the game in accordance with one or more resolutions of the sequence of adjudication dependencies, wherein the proposed response includes one or more of a rule adjudication or a particular game operation of the one or more game operations; and
a response handler of the game application that is configured to:
   compare the associated validation metric value to a validation threshold, and
   in response to the associated validation metric value failing to satisfy the validation threshold, transmit a request for supplemental information that identifies one or more adjudication dependencies whose respective resolutions are absent from the user input, wherein the respective resolutions of the one or more adjudication dependencies are configured to modify the associated validation metric value to the user interface.
16. The game application of example 15, wherein the user interface is further configured to:
display an indication of the request for the supplemental information; and
in response to receiving additional user input, update the user interface to display the additional user input.
17. The game application of example 15, wherein the data access interface is further configured to:
retrieve, from the data structure, information that identifies at least one of a current game phase, player resources, or card attributes.
18. The game application of example 15, further comprising:

a validation module of the game application configured to apply a plurality of independent validation models to the proposed response, each validation model configured to assess a different validation criteria that includes one or more of topic relevance, localization, completeness, hallucination, profanity, jailbreak, accuracy, format, user feedback, difficulty level, or temporal relevance.
19. The game application of example 18, wherein the validation module is further configured to:
in response to at least one validation model that indicates that the proposed response fails to satisfy a respective validation criteria, trigger the response handler to generate the request for the supplemental information via the user interface.
20. The game application of example 19, wherein the validation module is further configured to:
in response to receiving additional user input, apply the plurality of independent validation models to a revised proposed response generated using the trained AI model based on the additional user input.
21. A computer-implemented method for constructing card deck lists of a card game using artificial intelligence (AI), the computer-implemented method comprising:
receiving a deck building query from a user interface of a computing device, wherein the deck building query is associated with a card collection that includes one or more reference cards;
establishing a deck archetype based on one or more of: (a) an archetype selection indicated within the deck building query or (b) a similarity metric between archetype attributes of the deck archetype and card attributes of the one or more reference cards within the card collection;
generating a first command set configured to direct an AI model to generate a set of deck slots in accordance with the established deck archetype, wherein each deck slot is linked to a card category;
generating a second command set configured to direct the AI model to categorize each card in the card collection into one or more card categories based on a function, a card effect, or a keyword of the card;
transmitting the first and second command set to the AI model, wherein the AI model is trained to populate the set of deck slots with one or more (a) categorized cards categorized in response to the second command set or (b) additional cards different from the cards within the card collection, linked to a common card category,
   wherein respective card categories of the set of deck slots are determined, in response to the first command set, independently from respective card categories of the categorized cards in the card collection determined, in response to the second command set; and
in response to receiving the populated set of deck slots from the AI model, presenting a representation of the populated set of deck slots to the user interface of the computing device.
22. The computer-implemented method of example 21, wherein establishing the deck archetype further comprises:

retrieving, via a retrieval-augmented generation (RAG) database, one or more meta deck lists from one or more of an external database or a third-party website, wherein the AI model is configured to generate one or more modifications to the one or more meta deck lists based on the card collection and a degree of similarity between the card collection and the one or more meta deck lists.
23 The computer-implemented method of example 21, wherein, in response to determining that one or more deck slots are unpopulated, the AI model is further configured to recommend one or more additional cards different from the cards in the card collection based on a respective card category of the unpopulated deck slot and the established deck archetype.
24. The computer-implemented method of example 21, wherein, in response to determining that the populated set of deck slots excludes a particular reference card, the AI model is further configured to generate an explanation describing the exclusion of the particular reference card within the populated set of deck slots.
25. The computer-implemented method of example 21, wherein establishing the deck archetype further comprises:
applying natural language processing (NLP) to identify the card attributes of each card in the card collection,
   wherein the card attributes include one or more of: a card type, a keyword, or a playstyle indicator, and
   wherein the archetype attributes include one or more of: a card type distribution, a mana curve characteristic, a gameplay function characteristic, a playstyle indicator, a deck list format, or a keyword.

### CONCLUSION

Consequently, alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

We claim:

1. A computer-implemented method for adjudicating rules during gameplay of a card game using artificial intelligence (AI), the computer-implemented method comprising:
receiving, via a computing device configured to execute a game application, a first input that includes a query associated with a card interaction or game board state of the card game, wherein the card game is defined by gameplay rules that are applied to card data;
determining a sequence of adjudication dependencies for the query whose resolutions are configured to deterministically define an outcome of the card interaction or game board state;
transmitting, using the game application, the query into an AI model trained to:
generate (a) a first outcome of the card interaction or the game board state that adjudicates the query in accordance with the gameplay rules and the card data and (b) a first confidence score associated with the first outcome, and
in response to a determination that the first confidence score is below a confidence threshold, generate a request for supplemental information that identifies one or more adjudication dependencies whose respective resolutions are absent from the query, wherein the respective resolutions of the one or more adjudication dependencies are configured to increase the first confidence score;
causing display of, using the game application, a representation of the request on the computing device;
receiving, via the computing device, a second input that identifies at least a portion of the supplemental information;
generating, using the AI model, (a) a second outcome of the card interaction or the game board state that adjudicates the query in accordance with the gameplay rules, the card data, and the second input, and (b) a second confidence score associated with the second outcome; and
in response to a determination that the second confidence score exceeds the confidence threshold, causing display of a representation of the second outcome on the computing device.

2. The computer-implemented method of claim 1, further comprising:
identifying, by the game application, a plurality of candidate outcomes responsive to the query based on the gameplay rules and card data;
ranking the plurality of candidate outcomes using the AI model based on a predefined metric; and
selecting, as the first outcome, a particular candidate outcome having a highest value of the predefined metric.

3. The computer-implemented method of claim 1, further comprising:
storing, in a memory accessible to the game application, a record of one or more of the queries, the first outcome, the first confidence score, the request for the supplemental information, the second input, the second outcome, or the second confidence score; and
associating the record with a user identifier.

4. The computer-implemented method of claim 1, further comprising:
generating, using the AI model, an explanation that describes a series of steps used to adjudicate the query; and
causing display of a representation of the explanation on the computing device concurrently with the second outcome.

5. The computer-implemented method of claim 1, further comprising:
determining, by the game application, that the query includes slang terminology absent from the gameplay rules;
mapping the slang terminology one or more game terms present in the gameplay rules; and
modifying the query to replace the slang terminology with the one or more game terms prior to transmitting the query to the AI model.

6. The computer-implemented method of claim 1, further comprising:
receiving, by the game application, an image or video of the game board state as a portion of the first input;
identifying query context that includes at least one of card identities or card positions from the image or video; and
transmitting the query context to the AI model.

7. The computer-implemented method of claim 1, further comprising:
decomposing the query into a sequence of sub-queries based on the gameplay rules and the card data, wherein each sub-query identifies the adjudication dependencies; and
sequentially transmitting, using the game application, the sequence of sub-queries into the AI model.

8. A computer-implemented method for generating gameplay advice during gameplay using artificial intelligence (AI), the computer-implemented method comprising:
executing, via a computing device, a game application that maintains a digital representation of a current state of a card game, wherein the card game is defined by gameplay rules that are applied to card data, and wherein the digital representation identifies one or more of current card attributes, player resources, or game phase information;
receiving, via the computing device, a command set for a generation of a game operation based on the digital representation;
determining a sequence of adjudication dependencies for the command set whose resolutions are configured to deterministically define an outcome of a card interaction applied on the current state of the card game;
applying, to (a) the digital representation and (b) the command set, an AI model trained on the gameplay rules and the card data to generate (a) a proposed game operation and (b) a first associated confidence metric, wherein the proposed game operation is configured to, when executed by the game application, cause a change in the digital representation of the card game by applying the card interaction to the current state of the card game in accordance one or more resolutions of the sequence of adjudication dependencies;
in response to determining that the first associated confidence metric fails to satisfy a confidence threshold, generating, via the game application, a request for supplemental information that identifies one or more adjudication dependencies whose respective resolutions are absent from the command set, wherein the respective resolutions of the one or more adjudication dependencies are configured to increase the first associated confidence metric;
receiving, via the computing device, a response comprising at least a portion of the supplemental information;
applying, to (a) the digital representation and (b) the command set, and (c) the response, the AI model to generate (a) a revised game operation and (b) a second associated confidence metric, wherein the second associated confidence metric satisfies the confidence threshold; and
causing, via the computing device, a representation of the revised game operation to be output via a user interface of the game application during gameplay.

9. The computer-implemented method of claim 8, wherein the proposed game operation is configured to, when executed by the game application, modify at least one of a card state, a player resource value, or a game phase indicator in accordance with the gameplay rules.

10. The computer-implemented method of claim 8, further comprising:
generating a graphical representation of the proposed game operation; and
causing the graphical representation to be output via the user interface.

11. The computer-implemented method of claim 8, further comprising:
receiving, by the game application, a user selection of the revised game operation; and
updating the digital representation of the card game by executing the revised game operation.

12. The computer-implemented method of claim 8, further comprising:
detecting, by the game application, a change in the digital representation during gameplay; and
automatically generating, using the AI model, an updated game operation based on the change.

13. The computer-implemented method of claim 8, further comprising:
prior to outputting the revised game operation via the user interface, validating the revised game operation using a plurality of independent validation models, wherein each validation model is configured to assess a different attribute of the revised game operation according to a respective pre-loaded query context of each validation model.

14. The computer-implemented method of claim 13, wherein the command set is generated subsequent to a determination generated using a particular validation model, wherein the determination indicates that the revised game operation fails to satisfy the respective pre-loaded query context of the particular validation model.

15. A game application for providing virtual gameplay assistance during gameplay of a game using artificial intelligence (AI), comprising:
a user interface instantiated by the game application on a computing device and configured to receive user input that requests gameplay assistance based on a state of the game indicated in the user input;
a data access interface of the game application that is configured to retrieve, from a memory accessible to the game application, a data structure representing a current configuration of the game, wherein the data structure identifies information corresponding to gameplay rules and game data;
a communication interface of the game application that is configured to:
determine a sequence of adjudication dependencies for the user input whose resolutions are configured to deterministically define one or more outcomes of one or more game operations applied on the state of the game, and
transmit the data structure and the user input to a trained AI model trained to generate a proposed response and an associated validation metric value by applying the one or more game operations on the state of the game in accordance with one or more resolutions of the sequence of adjudication dependencies, wherein the proposed response includes one or more of a rule adjudication or a particular game operation of the one or more game operations; and
a response handler of the game application that is configured to:
compare the associated validation metric value to a validation threshold, and
in response to the associated validation metric value failing to satisfy the validation threshold, transmit a request for supplemental information that identifies one or more adjudication dependencies whose respective resolutions are absent from the user input, wherein the respective resolutions of the one or more adjudication dependencies are configured to modify the associated validation metric value to the user interface.

16. The game application of claim 15, wherein the user interface is further configured to:
display an indication of the request for the supplemental information; and
in response to receiving additional user input, update the user interface to display the additional user input.

17. The game application of claim 15, wherein the data access interface is further configured to:
retrieve, from the data structure, information that identifies at least one of a current game phase, player resources, or card attributes.

18. The game application of claim 15, further comprising:
a validation module of the game application configured to apply a plurality of independent validation models to the proposed response, each validation model configured to assess a different validation criteria that includes one or more of topic relevance, localization, completeness, hallucination, profanity, jailbreak, accuracy, format, user feedback, difficulty level, or temporal relevance.

19. The game application of claim 18, wherein the validation module is further configured to:
in response to at least one validation model that indicates that the proposed response fails to satisfy a respective validation criteria, trigger the response handler to generate the request for the supplemental information via the user interface.

20. The game application of claim 19, wherein the validation module is further configured to:
in response to receiving additional user input, apply the plurality of independent validation models to a revised proposed response generated using the trained AI model based on the additional user input.
